(19) United States
(12) Patent Application Publication
(10) Pub. No.: US 2016/0362345 A1
(43) Pub. Date: Dec. 15, 2016

(54) Extruded Seed and Plant Supporting Granular Media

(71) Applicant: Pioneer Pet Products, LLC, Cedarburg, WI (US)

(72) Inventor: John M. Lipscomb, Cedarburg, WI (US)

(21) Appl. No.: 15/069,956

(22) Filed: Mar. 14, 2016

Related U.S. Application Data
(60) Provisional application No. 62/103,066, filed on Jan. 13, 2015.

(51) Int. Cl. C05G 3/00; C05G 3/02; A01C 1/04; C05F 11/00

(52) U.S. Cl. CPC C05G 3/0047; C05F 11/00; C05G 3/02; C05G 3/0058; A01C 1/046

(57) ABSTRACT

A granular seed germination facilitating and plant growth supporting media formed of a plurality of granules including at least a plurality of starch-containing granules each preferably composed of a pellet extruded from a starch mixture forming extruded seed germination facilitating and plant growth supporting granules each containing water-soluble starch that more immediately activates upon coming into contact with moisture and containing less water soluble, e.g., insoluble material including cold water insoluble starch which provides seed germinating and and/or plant growth promoting material over an extended period of time. Such a media can be used to germinate and and/or facilitate distribution of seeds. A plurality of extruded pellets can be attached to a single seed and a plurality seeds can be attached to a single extruded pellet producing seed carrying germination initiating starch-containing granules that can be used independently or together with the media.

### CROSS REFERENCE

This application claims priority in U.S. Provisional Patent Application No. 62/103,066, filed Jan. 13, 2015, under 35 U.S.C. §119(e), the entirety of which is hereby expressly incorporated herein by reference.

### FIELD

The present invention is directed to extruded seed and/or plant supporting granular media and more particularly to a method of making and using the same.

### BACKGROUND

Planting grass seed can be a unique challenge because grass seed in particular tends to form clumps of seeds rather than the seeds distributing themselves evenly across the area in which the grass seed is desired to be planted. Further contributing to the challenges of planting grass seed is that the seeds are so light and fine that the seeds tend to blow away during and after planting only to end up floating away when watered. As a result, if one is able to get the grass seed to actually grow, it ends up growing unevenly in patches oftentimes requiring even more grass seed to subsequently be planted. Another challenge often encountered with grass seed, is actually getting planted seed to germinate and grow. Even when covered by mulch and properly watered, it is not unusual for at least some of the planted seed to fail to germinate.

These challenges are not unique to grass seed but apply to most types of fine seed, including carrot seed, onion seed and other types of fine seeds. In fact, one or more of these types of challenges can be and typically are encountered when trying to grow just about any type of plant from a seed.

What is needed is a method and seed delivery agent capable of not only facilitating planting of such seed, but which also helps enable seeds planted to be planted in the proper place and which also facilitates seed germination and/or post-germination plant growth.

### SUMMARY

The present invention is directed to granular plant supporting media that includes starch-containing granules preferably formed of pellets extruded from a starch-containing mixture well suited not only for supporting existing plants but also well suited for promoting seed germination and post-germination growth. The present invention also is directed to a method of making granular plant supporting media that includes granules, preferably pellets, extruded from starch and protein containing material sufficient to not only provide starch and protein for consumption by nitrogen fixing bacteria providing nitrogen that facilitates plant growth but which also produces water soluble binder sufficient for clumping and anchoring everything in place when applied.

The present invention is therefore directed to such a granular plant supporting media containing or formed of such extruded pellets that produces granular plant supporting media advantageously well suited for facilitating germination of seeds and supporting post-germination plant growth, a method of making the same, a method of using the same to seeds to support germination and growth thereof, seed germination initiating and plant growth supporting granules each formed of at least one seed and at least one starch-containing pellet extruded from a starch-containing mixture, and and/or starch-containing seed germination initiating and plant growth supporting granules each formed of a plurality of seeds each attached to or otherwise carried by a single pellet extruded from a starch-containing mixture. Each extruded pellet advantageously not only releases over an extended period of time moisture absorbed to help initiate seed germination and and/or facilitate plant growth, but each extruded pellet is extruded from a starch-containing mixture or material such that the starch in each extruded pellet provides an extended time release plant supporting medium that can release or form fertilizer during biodegradation thereof. Protein in each extruded pellet of such a granular plant supporting media of the present invention advantageously helps grow and nourish nitrogen fixing bacteria, which in turn fixes nitrogen beneficial for plant growth, thereby providing nitrogen as an extended time release plant supporting medium that helps germinated seeds grow into plants and/or existing plants grow.

The starch and protein in each extruded pellet can also carry and and/or facilitate growth of one or more strains of plant beneficial bacteria and/or one or more strains of root inoculants including by providing a bacteria and and/or inoculant growth medium, much like agar, as the starch in each granule biodegrades over time.

The present invention is directed to a seed and/or plant supporting granular media formed of extruded pellets that not only can be used by themselves to help support germination, sprouting, growth and/or health of seeds and/or plants but which also can be used as a seed distribution agent that carries one or more seeds per plant or flora supporting granule, preferably per extruded starch-containing pellet that can be spread on the ground or even planted in the ground. Where used as a seed distribution agent, each extruded granule or pellet of seed and/or plant supporting granular media helps support germination, sprouting, growth and/or health of the seed(s) carried by the granules or pellets preferably through at least germination, sprouting and initial growth of the seed(s) into a plant(s).

In a preferred embodiment, granules are extruded from a starch-containing mixture forming extruded pellets which can be used as plant or flora supporting granules of a preferred granular plant or flora supporting media of the present invention well suited for fertilizer use, facilitating seed germination, treating seeds and/or plants, and and/or helping to support or otherwise enhance plant growth. In a preferred plant or flora supporting media embodiment, the media is formed of at least a plurality of pairs of plant or flora supporting granules including at least a plurality of pairs of extruded starch-containing pellets and which can also include a plurality of pairs of more finely sized particles, e.g. fines, extruded from starch and and/or one or more non-extruded granules including one or more non-extruded plant treating particles, one or more fertilizer particles, e.g., micronutrients, one or more insecticide particles, one or more plant beneficial bacteria carrying particles, e.g., particles carrying nitrogen-fixing bacteria, and and/or one or more plant beneficial inoculant carrying particles, e.g., particles carrying inoculant fungi.

If desired, such granular plant or flora supporting media of the present invention can also include seeds either mixed there with or carried by one or more plant or flora supporting granules. In one such preferred granular plant or flora supporting media embodiment that includes seeds, there seeds can be freely mixed in with the rest of the plant or flora supporting granules producing a media mixture where the seeds in granules are all applied on the ground or planted in the ground together. In one such preferred embodiment, the seeds and extruded pellets are mixed together dry forming a granular plant or flora supporting media that is stored ready for use in a dry condition with the seeds not attached to the pellets and the pellets not attached to the seeds. Where such a preferred embodiment of granular plant or flora supporting media is a dry mixture of seeds and extruded pellets, it can also contain fines, non-extruded granules and non-extruded pellets which preferably are also not attached to any seed. Where such a preferred embodiment of granular plant or flora supporting media is a dry mixture of seeds and extruded pellets, it can be and preferably is applied together with water or an aqueous solution that can and preferably does activate any living organism, e.g., bacteria, such as nitrogen fixing bacteria, and/or inoculant, e.g., inoculating fungi, contained therein. It can be entrained in a stream of water or aqueous solution that wets the mixture as it is carried by the stream in being applied on the ground or other desired application area. It can also be applied dry on the ground before wetted with water or another aqueous solution, if desired.

In another preferred granular plant or flora supporting media embodiment, each seed has one or more extruded pellets and/or extruded fines attached thereto preferably via adhesive attachment using starch-based water-soluble binder in and/or or from the pellets and and/or fines being attached thereto or using such starch-based water-soluble binder obtained from other sources including other pellets and and/or fines. In still another preferred granular plant or flora supporting media embodiment, each one of the extruded pellets can be extruded with a plurality, preferably a plurality of pairs, i.e. at least three, seeds and and/or can carry a plurality, preferably a plurality of pairs, i.e. at least three, seeds adhesively attached thereto by such starch-based water-soluble binder.

In still another preferred granular or flora supporting media embodiment, polyvinyl alcohol can be used to facilitate seed and extruded pellet attached being used to adhesively attach one to the other. If desired, the seeds can be pretreated with polyvinyl alcohol to produce an outer surface of each seed, e.g., polyvinyl alcohol coating around each seed, making seed to pellet attachment more amenable before being adhesively attached to pellet(s) via water soluble binder adhesive attachment. In a further preferred granular or flora supporting media embodiment, polyvinyl acetate can be used to facilitate seed and extruded pellet attached being used to adhesively attach one to the other. If desired, the seeds can be pretreated with polyvinyl acetate to produce an outer surface of each seed, e.g., polyvinyl acetate coating around each seed, making seed to pellet attachment more amenable before being adhesively attached to pellet(s) via water soluble binder adhesive attachment.

In a preferred embodiment, one or more of the extruded pellets are impregnated, coated or otherwise treated with nitrogen fixing bacteria, preferably free living nitrogen fixing bacteria, such as one or more of clostridium, klebsiella, rhodobacter, nostoc, and/or azotobacter, in a form which activate or become activated when the pellets are wetted with water or another aqueous solution. In another preferred embodiment, one or more pellets of the granular plant supporting media are impregnated, coated or otherwise treated with symbiotic nitrogen fixing bacteria, such as one or more of rhizobium and/or azospirillum, depending on the nature of the seeds and/or plant media to be nourished with nitrogen produced from such symbiotic nitrogen fixing bacteria.

In use and operation, granules of the plant or flora supporting media are applied in the desired area by spreading the granules on the ground and water preferably is used to activate the granules to cause them to at least begin to release their respective treatments, fertilizers, plant beneficial bacteria and and/or plant beneficial inoculants. Application of water not only causes such activation but also causes plant or flora supporting granules formed of extruded pellets to at least partially solubilize thereby releasing solubilize starch into the surroundings providing plant supporting starch that can help facilitate more rapid seed germination and and/or plant growth.

In addition, the water also dissolves at least some starch-based water soluble binder, preferably cold water soluble binder, more preferably amylopectin cold water soluble binder, present in each wetted extruded pellet making an outer surface of each wetted pellet sticky or tacky enabling them to at least loosely adhere to other plant or flora supporting granules, seeds, plants and and/or roots in contact therewith helping to anchor the plant or flora supporting media thereto. Doing so not only helps prevent plant or flora supporting granules of the media from being blown away, but also causes water to be absorbed by the extruded pellets that is then released more slowly over at least a plurality of days to speed seed germination, improve soil moisture content, facilitate plant growth and and/or help promote root growth. In addition, where such extruded pellets are used in seed attachment, such as by being attached to a seed or having one or more seeds attached thereto, wetting of such extruded pellets to release such starch-based water-soluble binder advantageously enables secure and strong seed attachment thereto

Such plant or flora supporting granules of such media, in particular the extruded starch-containing pellets and/or fines of seed and/or plant supporting granular media of the present invention are also suited for use in aquaculture applications including as a fertilizer, treatment delivery vehicle or vector, bulking agent, and/or seed distributing/seed distribution agent.

### DRAWING DESCRIPTION

One or more preferred exemplary embodiments of the invention are illustrated in the accompanying drawings in which like reference numerals represent like parts throughout and in which:

FIG. 1 illustrates a preferred but exemplary embodiment of granular plant or flora supporting media of the present invention that is a mixture of plant or flora supporting granules including extruded starch providing pellets that also is well suited for initiating seed germination and post germination plant growth;

FIG. 2 illustrates a plurality of differently shaped extruded plant or flora supporting pellets which can also be adhesively bound to one or more seeds and and/or which can each carry a plurality of seeds;

FIG. 3 is a top plan view of a mass of plant or flora supporting granules of granular plant or flora supporting media of the present invention illustrating use an application thereof through application of such granules onto soil in the vicinity of seeds and/or growing plants to provide support thereto;

FIG. 4 is a side elevation view of the mass of plant or flora supporting granules of FIG. 3 illustrating stacking of granules on top of one another preferably forming at least one layer of granules on top of the soil covered therewith;

FIG. 5 is a top plan view of the mass of plant or flora supporting granules of FIG. 3 agglomerated in to a wetted soil or ground covering plant or flora supporting mass after activation thereof through application of water thereon that produces a substantially solid moisture releasing and and/or moisture loss inhibiting soil or ground covering mass;

FIG. 6 is a top plan view of a seed carrying germination initiating and post germination plant growth supporting granule formed of a seed covered with plant or flora supporting granules having improved seed germination initiating moisture retention which also break down over time to provide fertilizer to the plant following seed germination;

FIG. 7 is a top plan view of the seed of FIG. 6 before adhesive attachment of the plant or flora supporting granules thereto preferably using starch-based water-soluble binder of or from plant or flora supporting granules extruded from a starch-containing mixture; and

FIG. 8 is a top plan view of a batch of the seed carrying germination initiating and post germination plant growth supporting granules of FIG. 6 before planting or spreading thereof.

Before explaining one or more embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and therefore should not be regarded as limiting.

### DETAILED DESCRIPTION

The present invention is directed to seed and/or plant supporting granular media formed of granules or pellets that preferably are extruded from a starch-containing mixture, e.g. admixture, producing granules or pellets that can be used by themselves to support seeds and/or plants but which also can also be applied to and/or carry seeds prior to being planted that are spread together with the seeds during planting to support their germination and/or growth.

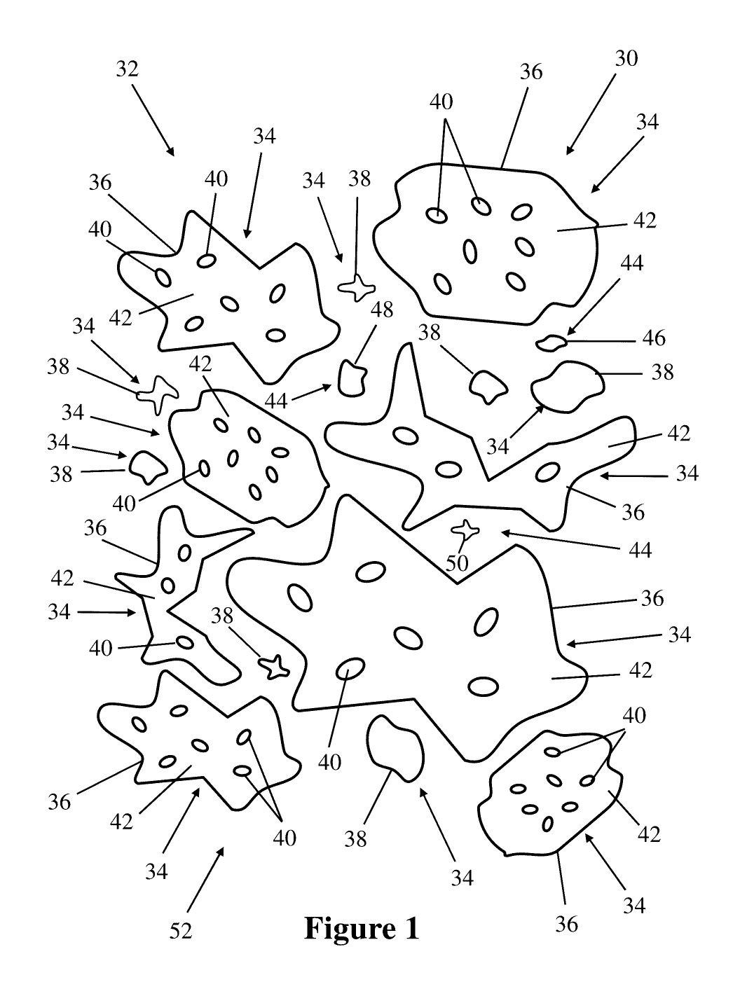

FIG. 1 depicts granular plant or flora supporting media 30 of the present invention that at least includes extruded plant or flora supporting media 32 formed of one or more growth supporting granules 34 extruded from a starch-containing growth supporting material that can and preferably does include one or more larger extruded pellets 36 and can and preferably also does include one or more smaller more finely sized extruded particles 38, e.g., fines. One or more of the extruded granules 34 can be and preferably are porous having one or more spaced apart pores 40 as depicted in FIG. 1 formed in an outer surface 42 of one or more of the extruded pellets 36 which can be and preferably are formed in the outer pellet surface 42 of each porous pellet 36 during extrusion and/or immediately upon extrusion.

If desired, granular plant or flora supporting media 30 of the present invention can also include non-extruded granules 44 composed of a type of plant or flora growth supporting material different than that of the extruded granules 32, such as one of more particles 46, 48 and/or 50 forming a plant or flora supporting granular mixture 52 of the present invention preferably composed of at least a plurality of pairs, i.e., at least three, of each type of granule 34 and 44. In one preferred mixture 52, each one of the non-extruded plant or flora supporting granules 44 is composed of a plant or flora supporting material, such as a fertilizer, pesticide, bactericide, fungicide or another type of plant supporting material. In one such preferred mixture, each granule 44 is composed of a fertilizer, such as one containing one or more nitrogen, potassium and/or phosphate fertilizers one or more of which can be inorganic, e.g., chemical, fertilizers. In another such preferred mixture, each granule 44 is composed of a pesticide, such as an organic biodegradable pesticide and/or inorganic pesticide to prevent insects and other pests from interfering with plant germination and/or growth.

In still another such preferred mixture 52, each granule 44 is composed of at least a plurality of different types of such non-extruded plant or flora supporting compounds with such a mixture 52 preferably containing at least a first such non-extruded particle 46 composed of such a fertilizer, e.g., micronutrients, a second such non-extruded particle 48 composed of such a pesticide, and a third such non-extruded particle 50 composed of one or more of such a bactericide(s), fungicide(s), anti-viral(s) and/or anti-yeast compound(s) with such a mixture 52 preferably containing at least a plurality of pairs of such non-extruded granules 44. In one such preferred mixture, mixture 52 preferably contains at least a plurality of pairs, i.e., at least three, of at least one of non-extruded particles 46, 48 and/or 50. In another such preferred mixture, mixture 52 preferably contains at least a plurality of pairs, i.e., at least three, of each one of different types of non-extruded particles 46, 48 and/or 50.

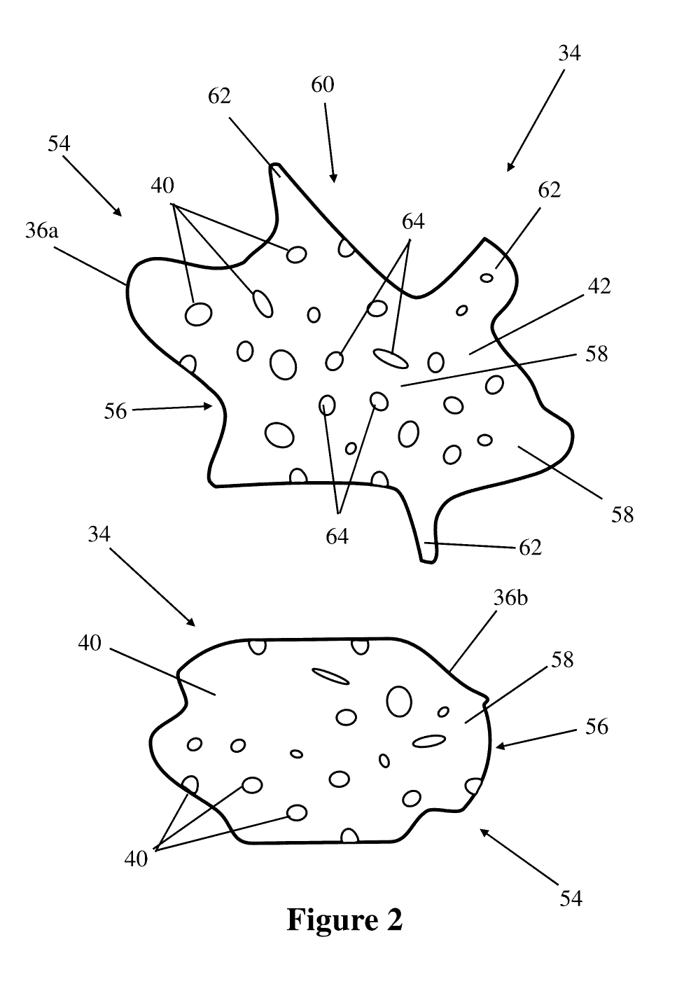

FIG. 2 illustrates a plurality of extruded plant or flora supporting pellets 36a and 36b in accordance with the present invention that are each composed of at least 40% starch by pellet weight, that are each preferably composed of at least 50% starch by pellet weight, and that are each more preferably composed of at least 60% starch by pellet weight which provides not only a source of plant food but which preferably also have at least a plurality, i.e. at least three, of pores 40 formed in their outer surface 42 and an extruded pellet interior with at least a plurality of pairs, i.e. at least three, of internal gas-filled, e.g. air-filled, pockets or voids formed therein producing pellets 36a and 36b that also function as liquid, e.g., water, absorbent sponges 54. Pellets 36a and 36b preferably are extruded from a starch-containing mixture, e.g., admixture, containing at least 40% starch by dry admixture weight, e.g. before any water is added, preferably containing at least 50% starch by dry admixture weight, and more preferably containing at least 60% starch by dry admixture weight. Such an admixture preferably has a moisture content no greater than 30%, preferably no greater than 28% and more preferably no greater than 25% to extrude plant or flora supporting pellets 36a and 36b in accordance with the present invention.

The starch-based admixture can also contain cellulosic material, such as in the form of cellulosic fiber, e.g., plant fiber, hemp, wood fiber, sawdust, or another source of cellulose and/or hemicellulose, in an amount no greater than 40% by dry admixture weight, e.g. before any water is added, preferably no greater than 35% by dry admixture weight, and more preferably no greater than 30% by dry admixture weight. Where the admixture contains cellulosic material, the use of such cellulosic material preferably facilitates water absorption and/or moisture retention, helps provide structural support to each pellet 36a and 36b extruded therewith, and can also provide a long-acting source plant or flora supporting food as the glucose units in the cellulosic material is broken down over time. Where the admixture contains such cellulosic material that provides such a long-acting source of plant or flora supporting food, the cellulosic material in each extruded pellet 36a and 36b advantageously provides plant or flora supporting food after all of the other plant or flora supporting food sources present in the pellets 36a and 36b, including starch-based plant or flora supporting food sources, have been consumed, spent or otherwise used up.

In a preferred admixture, preferred sources of starch include starch from one or more cereal grains, such as from one or more of corn, maize, sorghum, rice, wheat, barley, rye, triticale, buckwheat, fonio, and/or quinoa, which can be comminuted into flour, meal, grits, and/or starch as known in the art. In one such preferred admixture, the admixture can be composed of whole grain seed kernels, which can be in comminuted form, such as in the form of grits, meal, flour or starch.

In one preferred admixture, whole grain corn, e.g., corn kernels or corn seed, whole grain sorghum, sorghum kernels or corn seeds, whole grain wheat, e.g., wheat seeds, whole grain rye, e.g., rye seed(s), whole grain rice, e.g., whole grain rice seed(s) or rice kernels, whole grain triticale, e.g., triticale kernels or seeds, and/or whole grain buckwheat, e.g., buckwheat kernels or seeds, are used. If desired, the whole grain cereal grain kernel(s) and/or seed(s) can be comminuted and/or in comminuted form, such as in the form of grits, meal, flour or starch of one or more of corn, maize, sorghum, rice, wheat, barley, rye, triticale, buckwheat, fonio, and/or quinoa.

In one preferred admixture, the admixture can include distillers grain(s), such as in the form of the byproduct from one or more of the aforementioned cereal grains after distillation, in an amount that makes up no more than 50% of the admixture by weight of the admixture before the admixture enters the extruder. In one such admixture, the admixture includes no more than 50% by admixture weight of wet or dry distillers grain, such as in the form of wet or dry distillers grain from corn, wheat, oats, rice and/or sorghum. In another such admixture, admixture includes no more than about 25%±5% wet distillers grain by total admixture weight, i.e., weight of the admixture before extrusion. In still another such admixture, the admixture has no more than about 35%±5% of dry distillers grain by total weight of the admixture before extrusion.

Where such a preferred admixture includes distillers grain(s), such as in the amounts and/or percentages disclosed in the preceding paragraph, the remainder of the admixture preferably is formed of one or more such cereal grains, preferably whole cereal grain(s), and/or which can also include comminuted cereal grain(s), such as disclosed prior to the preceding paragraph. If desired, such an admixture can also include cellulosic material, such as in the form, amount(s) and/or weight percentages desired hereinabove.

In another preferred admixture, another source of starch can be used, such as potato starch, as the sole source of starch of the admixture or can form one starch-containing component of the admixture. Where used as a component of the admixture, such a non-cereal grain-based form of starch, e.g. potato starch, preferably is mixed with one or more of the aforementioned cereal grains to produce an admixture from which plant or flora supporting pellets 36a and 36b are extruded. Where the admixture includes starch from potato or potatoes, such potato starch preferably makes up no more than 50% of the admixture by weight of the admixture before the admixture enters the extruder. In one preferred admixture, potato starch preferably makes up no more than about 25%±5% of the admixture by weight of the admixture before extrusion.

Where such a preferred admixture includes potato starch, such as in the amounts and/or percentages disclosed in the preceding paragraph, the remainder of the admixture preferably is formed of one or more such cereal grains, preferably whole cereal grain(s), as disclosed hereinabove, and/or which can also include comminuted cereal grain(s). If desired, such an admixture can also include cellulosic material, such as in the form, amount(s) and/or weight percentages desired hereinabove.

If desired, an admixture in accordance with the present invention can include or be composed of (a) one or more cereal grains in whole grain form, which can be comminuted into grits, meal, flour and/or starch form, used in the admixture in whole grain form, composed of a combination of whole grain cereal grain(s) and/or comminuted cereal grain(s), (b) one or more distillers grain(s), (c) potato starch(es), and/or (d) cellulose, e.g., cellulosic material. In one such preferred admixture, the admixture preferably contains no more than about 25%±5% cellulose or cellulosic material, no more than about 25%±5% distillers grain(s), and/or no more than about 25%±5% potato starch(es) with the remainder of the admixture composed substantially completely of one or more cereal grains that can be in whole grain or kernel form.

Such an admixture is formulated to possess enough starch to produce water soluble binder in each extruded pellet 36a and/or 36b as discussed in more detail elsewhere herein and will also contain enough protein and starch to feed seed germinating and/or plant growth supporting bacteria, preferably nitrogen fixing bacteria, as discussed in more detail elsewhere herein. A preferred admixture will possess enough starch to not only form sufficient water soluble binder in each extruded pellet 36a and/or 36b during or from pellet extrusion but will also have enough starch present that is not in the form of water soluble binder that will provide food for such nitrogen fixing bacteria. Such a preferred admixture will also have at least 5%, preferably at least 7%, and more preferably at least 8.5% protein by weight of the admixture before extrusion to provide sufficient protein for such nitrogen fixing bacteria to consume enough of the protein in order to carry out nitrogen fixing after application of the pellets 36a and/or 36b on the ground.

In one preferred method of extruding plant or flora supporting pellets 36a and 36b, with the exception of any cellulosic material, the admixture is at least partially or substantially completely composed of one or more whole grain cereal grains, such as one or more of corn, maize, sorghum, rice, wheat, barley, rye, triticale, buckwheat, fonio, and/or quinoa, extruded in their whole grain form to produce plant or flora supporting pellets 36a and 36b. In one preferred admixture and method, whole grain sorghum kernels, e.g., sorghum seed kernels, which can be degermed or in a degermed form, are used in the admixture and enter the extruder in their whole grain kernel form. In another preferred admixture and method, whole grain corn kernels, e.g., corn seed kernels, which can be degermed or in a degermed form, are used in the admixture and enter the extruder in their whole grain kernel form. As previously mentioned, at least some of the starch of such an admixture containing whole grains, e.g., whole grain seed kernels, and/or degermed whole grains, seed kernels that have been de-germed, can be provided by a non-cereal grain form of starch, such as potato starch.

The admixture is extruded by a single screw or twin screw extruder at an extruder exit die temperature(s) and extruder exit die pressure(s) sufficient to not only form starch-based plant or flora supporting pellets 36a and 36b containing starch that provides plant or flora support, preferably in the form of plant or flora food, e.g. in the form of carbohydrates or glucose, but which also produces pellets 36a and 36b which preferably are also porous and/or which preferably also have an internal void filled or pocket filled starch matrix pellet structure that increases plant or flora facilitating moisture absorption, retention and/or release. In a preferred plant or flora pellet extrusion method, the admixture is extruded by the extruder at an extruder temperature and pressure sufficient to at least partially expand or puff each pellet 36a and 36b to form pellets 36a and 36b having such outer surface porosity and void filled internal starch matrix.

In a particularly preferred method of making plant or flora supporting pellets 36a and 36b, the admixture is extruded by the extruder at an extruder temperature and pressure sufficient not only to form porous and void filled plant or flora supporting pellets 36a and 36b, but also to physically and/or thermodynamically modify at least some of the starch present in the admixture during extrusion to form adhesive in each pellet 36a and 36b when the pellets 36a and 36b are wetted with water in an amount sufficient to at least lightly adhere pellets 36a and 36b to one another and/or to other particles, e.g. extruded particles 38, and/or to other granules, e.g., granule(s) 44, in accordance with the present invention. In one preferred method, the admixture is extruded by the extruder at an extruder temperature and pressure sufficient to also form binder that is soluble in a liquid that preferably is water, i.e., water soluble binder, in each extruded plant or flora supporting pellet 36a and 36b, preferably cold water soluble binder that is water soluble at room temperatures, e.g. water soluble at temperatures between 50° F. and 75° F., which at least partially dissolves or solubilizes when wetted with water in forming an amount of flowable adhesive that flows from, around, onto and/or in between wetted pellets 36a and 36b and/or to other particles, e.g. extruded particles 38, and/or to other granules, e.g., granule(s) 44, with the amount of such flowable adhesive formed sufficient to at least at least lightly adhere pellets 36a and 36b to one another and/or to other particles, e.g. extruded particles 38, and/or to other granules, e.g., granule(s) 44. In one preferred method, the admixture is extruded by the extruder at an extruder temperature and pressure sufficient to form water soluble binder in each extruded plant or flora supporting pellet 36a and 36b, preferably cold water soluble binder, in an amount sufficient to produce flowable adhesive that flows from, around, onto and/or in between pellets 36a and 36b when wetted with water that firmly and/or strongly binds the pellets 36a and 36b to one another and/or to other particles, e.g. extruded particles 38, and/or to other granules, e.g., granule(s) 44.

Such water soluble binder containing extruded plant or flora supporting pellets 36a and 36b of the present invention not only enable attachment of one or more particles, such as one or more seeds, thereto and/or enable attachment of one or more pellets 36a and 36b to a single particle, such as to single seeds, but which also form a plant or flora supporting mass on the ground, e.g. soil, when granular plant or flora supporting media 30 of the present invention is applied on the ground, e.g. soil, and wetted with water during or after application. Where plant or flora supporting pellets 36a and 36b are attached to one or more seeds or have one or more seeds attached thereto prior to ground application and application wetting, pellets 36a and 36b can be wetted during seed attachment to solubilize at least some water soluble binder of each pellet 36a and 36b to make it sufficiently tacky or sticky for seed attachment to occur or a solution containing such water soluble binder, preferably obtained from water soluble binder containing extruded pellets, e.g. other pellets 36a and 36b and/or other pellets similarly extruded under conditions producing water soluble binder in more preferably cold water soluble binder, can be sprayed thereon to cause seed attachment in a seed attachment step.

In a preferred plant or flora supporting pellet extrusion method, the admixture is extruded from the extruder, preferably a single screw extruder, at an extrusion temperature of at least 100° C. at the extrusion die and at an extrusion temperature of at least 2000 pounds per square inch and at the extrusion die to provide an extrusion temperature and pressure sufficient to physically and/or thermodynamically modify starch in the admixture to form such water soluble binder, preferably cold water soluble binder, and more preferably amylopectin cold water soluble binder, in each plant or flora supporting pellet 36a and 36b in an amount sufficient to produce enough such flowable adhesive when the pellets 36a and 36b are wetted with water to perform as discussed above during seed attachment and/or ground application. Extrusion at such a high extrusion pressure advantageously destroys any aflatoxin in the cereal grain(s) used in the admixture extruded into the pellets. In one such preferred pellet extrusion method, such a sufficient amount of water soluble binder, preferably cold water soluble binder, and more preferably amylopectin cold water soluble binder, is formed in each pellet 36a and 36b from starch in the admixture without any other binder being present in the admixture. Such a sufficient amount of water soluble binder in each pellet 36a and 36a advantageously enables them to bind with each other and any other particles or granules of granular plant or flora supporting media 30 of the present invention when applied to the ground and wetted.

In one preferred pellet extrusion method, the admixture is extruded from the extruder, preferably a single screw extruder, at an extrusion temperature of at least 100° C. at the extrusion die and at an extrusion temperature of at least 2000 pounds per square inch to produce pellets 36a and 36b each having at least 5% water soluble binder, preferably cold water soluble binder, and more preferably amylopectin cold water soluble binder, which forms flowable adhesive when the pellets 36a and 36b are wetted with water sufficient to adhere them, bind them and/or clump them together and/or to one or more other particles or granules. Extrusion at such a high extrusion pressure advantageously destroys any aflatoxin in the cereal grain(s) used in the admixture extruded into the pellets. In one such preferred pellet extrusion method, such a sufficient amount of water soluble binder, preferably cold water soluble binder, and more preferably amylopectin cold water soluble binder, is formed in each pellet 36a and 36b from starch in the admixture without any other binder being present in the admixture. Such a sufficient amount of water soluble binder in each pellet 36a and 36a advantageously enables them to bind with each other and any other particles or granules of granular plant or flora supporting media 30 of the present invention when applied to the ground and wetted.

In another preferred pellet extrusion method, the admixture is extruded from the extruder, preferably a single screw extruder, at an extrusion temperature of at least 100° C. at the extrusion die and at an extrusion temperature of at least 2000 pounds per square inch to produce pellets 36a and 36b each having at least 7% water soluble binder, preferably cold water soluble binder, and more preferably amylopectin cold water soluble binder, which forms flowable adhesive when the pellets 36a and 36b are wetted with water sufficient to adhere them, bind them and/or clump them together and/or to one or more other particles or granules. Extrusion at such a high extrusion pressure advantageously destroys any aflatoxin in the cereal grain(s) used in the admixture extruded into the pellets. In one such preferred pellet extrusion method, such a sufficient amount of water soluble binder, preferably cold water soluble binder, and more preferably amylopectin cold water soluble binder, is formed in each pellet 36a and 36b from starch in the admixture without any other binder being present in the admixture. Such a sufficient amount of water soluble binder in each pellet 36a and 36a advantageously enables them to bind with each other and any other particles or granules of granular plant or flora supporting media 30 of the present invention when applied to the ground and wetted

In still another preferred pellet extrusion method, the admixture is extruded from the extruder, preferably a single screw extruder, at an extrusion temperature of at least 100° C. at the extrusion die and at an extrusion temperature of at least 2000 pounds per square inch to produce pellets 36a and 36b each having at least 10% water soluble binder, preferably cold water soluble binder, and more preferably amylopectin cold water soluble binder, which forms flowable adhesive when the pellets 36a and 36b are wetted with water sufficient to adhere them, bind them and/or clump them together and/or to one or more other particles or granules. Extrusion at such a high extrusion pressure advantageously destroys any aflatoxin in the cereal grain(s) used in the admixture extruded into the pellets. In one such preferred pellet extrusion method, such a sufficient amount of water soluble binder, preferably cold water soluble binder, and more preferably amylopectin cold water soluble binder, is formed in each pellet 36a and 36b from starch in the admixture without any other binder being present in the admixture. Such a sufficient amount of water soluble binder in each pellet 36a and 36a advantageously enables them to bind with each other and any other particles or granules of granular plant or flora supporting media 30 of the present invention when applied to the ground and wetted.

In yet another preferred pellet extrusion method, the admixture is extruded from the extruder, preferably a single screw extruder, at an extrusion temperature of at least 120° C. at the extrusion die and at an extrusion temperature of at least 2500 pounds per square inch to produce pellets 36a and 36b each having at least 10% water soluble binder, preferably cold water soluble binder, and more preferably amylopectin cold water soluble binder, which forms flowable adhesive when the pellets 36a and 36b are wetted with water sufficient to adhere them, bind them and/or clump them together and/or to one or more other particles or granules. In one such preferred pellet extrusion method, such a sufficient amount of water soluble binder, preferably cold water soluble binder, and more preferably amylopectin cold water soluble binder, is formed in each pellet 36a and 36b from starch in the admixture without any other binder being present in the admixture. Such a sufficient amount of water soluble binder in each pellet 36a and 36a advantageously enables them to bind with each other and any other particles or granules of granular plant or flora supporting media 30 of the present invention when applied to the ground and wetted.

In a further preferred pellet extrusion method, the admixture is extruded from the extruder, preferably a single screw extruder, at an extrusion temperature of at least 100° C. at the extrusion die and at an extrusion temperature of at least 2000 pounds per square inch to produce pellets 36a and 36b each having at least 15% water soluble binder, preferably cold water soluble binder, and more preferably amylopectin cold water soluble binder, which forms flowable adhesive when the pellets 36a and 36b are wetted with water sufficient to adhere them, bind them and/or clump them together and/or to one or more other particles or granules. Extrusion at such a high extrusion pressure advantageously destroys any aflatoxin in the cereal grain(s) used in the admixture extruded into the pellets. In one such preferred pellet extrusion method, such a sufficient amount of water soluble binder, preferably cold water soluble binder, and more preferably amylopectin cold water soluble binder, is formed in each pellet 36a and 36b from starch in the admixture without any other binder being present in the admixture. Such a sufficient amount of water soluble binder in each pellet 36a and 36a advantageously enables them to bind with each other and any other particles or granules of granular plant or flora supporting media 30 of the present invention when applied to the ground and wetted.

In a still further preferred pellet extrusion method, the admixture is extruded from the extruder, preferably a single screw extruder, at an extrusion temperature of at least 110° C. at the extrusion die and at an extrusion temperature of at least 2500 pounds per square inch to produce pellets 36a and 36b each having at least 15% water soluble binder, preferably cold water soluble binder, and more preferably amylopectin cold water soluble binder, which forms flowable adhesive when the pellets 36a and 36b are wetted with water sufficient to adhere them, bind them and/or clump them together and/or to one or more other particles or granules. In one such preferred pellet extrusion method, such a sufficient amount of water soluble binder, preferably cold water soluble binder, and more preferably amylopectin cold water soluble binder, is formed in each pellet 36a and 36b from starch in the admixture without any other binder being present in the admixture. Such a sufficient amount of water soluble binder in each pellet 36a and 36a advantageously enables them to bind with each other and any other particles or granules of granular plant or flora supporting media 30 of the present invention when applied to the ground and wetted.

In yet another preferred pellet extrusion method, the admixture is extruded from the extruder, preferably a single screw extruder, at an extrusion temperature of at least 110° C. at the extrusion die and at an extrusion temperature of at least 3000 pounds per square inch to produce pellets 36a and 36b each having at least 15% water soluble binder, preferably cold water soluble binder, and more preferably amylopectin cold water soluble binder, which forms flowable adhesive when the pellets 36a and 36b are wetted with water sufficient to adhere them, bind them and/or clump them together and/or to one or more other particles or granules. Extrusion at such a high extrusion pressure advantageously destroys any aflatoxin in the cereal grain(s) used in the admixture extruded into the pellets. In one such preferred pellet extrusion method, such a sufficient amount of water soluble binder, preferably cold water soluble binder, and more preferably amylopectin cold water soluble binder, is formed in each pellet 36a and 36b from starch in the admixture without any other binder being present in the admixture. Such a sufficient amount of water soluble binder in each pellet 36a and 36a advantageously enables them to bind with each other and any other particles or granules of granular plant or flora supporting media 30 of the present invention when applied to the ground and wetted.

In yet another preferred pellet extrusion method, the admixture is extruded from the extruder, preferably a single screw extruder, at an extrusion temperature of at least 125° C. at the extrusion die and at an extrusion temperature of at least 3000 pounds per square inch to produce pellets 36a and 36b each having at least 20% water soluble binder, preferably cold water soluble binder, and more preferably amylopectin cold water soluble binder, which forms flowable adhesive when the pellets 36a and 36b are wetted with water sufficient to adhere them, bind them and/or clump them together and/or to one or more other particles or granules. Extrusion at such a high extrusion pressure advantageously destroys any aflatoxin in the cereal grain(s) in the admixture used to extrude the pellets 36a and/or 36b. In one such preferred pellet extrusion method, such a sufficient amount of water soluble binder, preferably cold water soluble binder, and more preferably amylopectin cold water soluble binder, is formed in each pellet 36a and 36b from starch in the admixture without any other binder being present in the admixture. Such a sufficient amount of water soluble binder in each pellet 36a and 36b advantageously enables them to bind with each other and any other particles or granules of granular plant or flora supporting media 30 of the present invention when applied to the ground and wetted.

In at least one such preferred embodiment, the admixture is extruded using a single screw extruder at a temperature of no greater than 165° C. at the extrusion die, preferably no greater than 150° C., and at a pressure of at least 2000 pounds per square inch, preferably at least 2500 pounds per square inch, more preferably at least 3000 pounds per square inch at the extrusion die, to produce extruded seed and plant growth supporting pellets 36a and/or 36b having at least 10% water soluble binder, preferably at least 15% water soluble binder, and more preferably at least 20% water soluble binder, and containing at least 40%, preferably at least 50% and more preferably at least 60% starch along with at least 5% protein, preferably at least 7% protein, and more preferably at least 8.5% protein by pellet weight in each extruded pellet 36a and/or 36b. As discussed in more detail herein, the starch present in each one of these extruded pellets 36a and/or 36b helps support seed germination and/or plant growth by being broken down or degraded over time into one or more constituents or byproducts that help facilitate seed germination and plant growth. In a preferred method, implementation and extruded pellet embodiment, extrusion of such an admixture using a single screw extruder in accordance with any one or more of the admixtures discussed above at such an extrusion pressure of at least 2000 pounds per square inch, preferably at least 2500 pounds per square inch, more preferably at least 3000 pounds per square inch at the extrusion die, the proteins in the admixture are preferably substantially uniformly distributed throughout each extruded pellet 36a and/or 36b thereby regulating nitrogen production by nitrogen fixing bacteria in a manner that produces a slow nitrogen release extruded pellet 36a and/or 36b of the present invention. In another preferred method and embodiment, the pellets are extruded at a temperature of at least 100 degrees Celsius, preferably at least 125 degrees Celsius, and at an extrusion pressure of at least 4000 pounds per square inch using a single screw extruder. In another preferred method and embodiment, the pellets are extruded at a temperature of at least 100 degrees Celsius, preferably at least 125 degrees Celsius, and at an extrusion pressure of at least 4500 pounds per square inch using a single screw extruder. Extrusion at such a high extrusion pressure also advantageously destroys any aflatoxin in the cereal grain(s) in the admixture used to extrude the pellets 36a and/or 36b. In such a preferred admixture and extruded pellet(s) 36a and/or 36b produced therefrom, the protein content of each such extruded pellet 36a and/or 36b along with the substantially uniform distribution of protein throughout each extruded pellet 36a and/or 36b causes nitrogen fixing bacteria to slowly release nitrogen when consuming the starch and protein therein over a period of at least a plurality of days, preferably over a period of at least a plurality of pairs, i.e., at least three, and more preferably over a period of at least five days.

With continued reference to FIG. 2, each plant or flora supporting pellet 36a and 36b extruded from such an admixture in accordance with such an extrusion method of the present invention has a pellet body 56 with a starch matrix 58 in which a sufficient amount of starches modified during pellet extrusion into forming such water soluble binder, preferably cold water soluble binder, more preferably amylopectin cold water soluble binder, is held with at least some of the binder forming or being disposed at the outer surface 42 of each pellet 36a and 36b enabling each pellet 36a and 36b to at least become tacky or sticky when wetted. The starch matrix 58 extends throughout the body 56 of each pellet 36a and 36b and includes the starches modified, preferably physically and/or thermodynamically modified, during extrusion to form water soluble binder, preferably cold water soluble binder, more preferably amylopectin cold water soluble binder, such that water soluble binder also is distributed, preferably substantially uniformly distributed, throughout the body 56 of each pellet 36a and 36b.

The pellets 36a and 36b can be and preferably are extruded in a manner that produces plant or flora supporting pellets in accordance with the present invention having different shapes, sizes and/or other characteristics. Although not shown in FIG. 2, plant or flora supporting pellets can be extruded that are circular, round, ball-shaped, disk-shaped, half-moon shaped, crescent-shaped, oblong and/or generally cylindrical.

In a preferred embodiment of plant or flora supporting media 30 of the present invention, the media 30 preferably is made of a mixture of extruded plant or flora supporting granules 32 having at least a plurality of different sizes with at least a plurality of pairs, i.e. at least three, of the extruded granules 32, preferably extruded pellets 36, e.g., extruded pellets 36a and/or 36b, having a size no smaller than 0.5 millimeters along the largest or longest extent of the pellet 36, e.g. along the width, length or diameter of the pellet 36 (whichever is largest/longest) and at least a plurality of pairs, i.e. at least three, extruded granules 32, preferably more finely sized extruded particles 38, being of a size smaller than the pellets 36 with each preferably having a size smaller than 0.5 millimeters along the largest or longest extent of the extruded fine 38. Such a preferred embodiment of plant or flora supporting media 30 of the present invention having multiple sizes of extruded plant or flora supporting granules 32 advantageously enables better coverage of the granules 32 when applied on the ground, when used in such ground applications, when applied onto one or more seeds, when used as seed germination and growth supporting media, and/or when one or more seeds are applied thereto, also when used as seed germination and growth supporting media.

The use of such larger size extruded plant or flora supporting granules 32 of pellets 36 each having a size no smaller than 0.5 millimeters advantageously helps extend the length of time each larger sized granule, preferably extruded pellets 36, is able to provide plant or flora beneficial support following use and/or ground application. The inclusion of such smaller size extruded plant or flora supporting granules 32 or fines 38 each having a size smaller than 0.5 millimeters advantageously helps provide smaller more finely sized starch-containing particles 38 that more rapidly provide plant or flora beneficial support upon being used, e.g., applied.

In one such preferred embodiment, such plant or flora supporting media 30 of the present invention has at least a plurality, preferably at least a plurality of pairs, i.e. at least three, of extruded plant or flora supporting granules 32 per cubic centimeter of the package media 30 each being an extruded pellet 36 each having a size no smaller than 0.5 millimeters such that each pellet 36 contains a sufficient amount of starch in a larger sized starch matrix that the starch from each pellet 36 is released in providing beneficial plant support more slowly, preferably at least over a duration of time of at least a plurality of pairs, i.e. at least three days, preferably over a duration of time of at least one week, and more preferably over a duration of time of at least a plurality, preferably a plurality of pairs, of weeks after ground application. In such a preferred embodiment, such plant or flora supporting media 30 of the present invention has at least a plurality, preferably at least a plurality of pairs, i.e. at least three, of extruded plant or flora supporting granules 32 per cubic centimeter of the package media 30 each being a smaller sized fine 36 each having a size smaller than 0.5 millimeters such that each fine 36 more rapidly releases its starch in providing beneficial plant support preferably over a duration of time of no more than a week and preferably no more than about three days following ground application.

In another preferred embodiment of plant or flora supporting media 30 of the present invention, the media 30 preferably is made of a mixture of extruded plant or flora supporting granules 32 having at least a plurality of different sizes with at least a plurality of pairs, i.e. at least three, of the extruded granules 32, preferably extruded pellets 36, e.g., extruded pellets 36a and/or 36b, having a size greater than 1.5 millimeters along the largest or longest extent of the pellet 36, e.g. along the width, length or diameter of the pellet 36 (whichever is largest/longest) and at least a plurality of pairs, i.e. at least three, extruded granules 32, preferably more finely sized extruded particles 38, being of a size smaller than the pellets 36 with each preferably having a size no greater than 1.5 millimeters along the largest or longest extent of the extruded fine 38. Such a preferred embodiment of plant or flora supporting media 30 of the present invention having multiple sizes of extruded plant or flora supporting granules 32 advantageously enables better coverage of the granules 32 when applied on the ground, when used in such ground applications, when applied onto one or more seeds, when used as seed germination and growth supporting media, and/or when one or more seeds are applied thereto, also when used as seed germination and growth supporting media.

The use of such larger size extruded plant or flora supporting granules 32 that includes extruded pellets 36 each having a size larger than 1.5 millimeters advantageously helps extend the length of time each larger sized granule, preferably extruded pellets 36, is able to provide plant or flora beneficial support following use and/or ground application. The inclusion of such smaller size extruded plant or flora supporting granules 32 or fines 38 each having a size no greater than 1.5 millimeters advantageously helps provide smaller more finely sized starch-containing particles 38 that more rapidly provide plant or flora beneficial support upon being used, e.g., applied.

In one such preferred embodiment, such plant or flora supporting media 30 of the present invention has at least a plurality, preferably at least a plurality of pairs, i.e. at least three, of extruded plant or flora supporting granules 32 per cubic centimeter of the package media 30 each being an extruded pellet 36 each having a size larger than 1.5 millimeters such that each pellet 36 being larger in size thereby advantageously contains more starch, preferably a sufficient amount or mass of starch in a larger sized starch matrix from such a larger sized pellet 36, such that the starch from each pellet 36 is released more slowly, preferably at least over a duration of time of at least a plurality of pairs, i.e. at least three days, preferably over a duration of time of at least one week, and more preferably over a duration of time of at least a plurality, preferably a plurality of pairs, of weeks after ground application advantageously providing beneficial plant support longer. In such a preferred embodiment, such plant or flora supporting media 30 of the present invention has at least a plurality, preferably at least a plurality of pairs, i.e. at least three, of extruded plant or flora supporting granules 32 per cubic centimeter of the package media 30 each being a smaller sized fine 36 each having a size no greater than 1.5 millimeters such that each fine 36 more rapidly releases its starch in providing beneficial plant support preferably over a duration of time of no more than a week and preferably no more than about three days following ground application.

In still another preferred embodiment of plant or flora supporting media 30 of the present invention, the media 30 preferably is made of a mixture of extruded plant or flora supporting granules 32 having at least a plurality of different sizes with at least a plurality of pairs, i.e. at least three, of the extruded granules 32, preferably extruded pellets 36, e.g., extruded pellets 36a and/or 36b, having a size no smaller than about 2 millimeters along the largest or longest extent of the pellet 36, e.g. along the width, length or diameter of the pellet 36 (whichever is largest/longest) and at least a plurality of pairs, i.e. at least three, extruded granules 32, preferably more finely sized extruded particles 38, being of a size smaller than the pellets 36 with each preferably having a size smaller than 2 millimeters along the largest or longest extent of the extruded fine 38. Such a preferred embodiment of plant or flora supporting media 30 of the present invention having multiple sizes of extruded plant or flora supporting granules 32 advantageously enables better coverage of the granules 32 when applied on the ground, when used in such ground applications, when applied onto one or more seeds, when used as seed germination and growth supporting media, and/or when one or more seeds are applied thereto, also when used as seed germination and growth supporting media.

The use of such larger size extruded plant or flora supporting granules 32 that includes extruded pellets 36 each having a size no smaller than 2 millimeters advantageously helps extend the length of time each larger sized granule, preferably extruded pellets 36, is able to provide plant or flora beneficial support following use and/or ground application. The inclusion of such smaller size extruded plant or flora supporting granules 32 or fines 38 each having a size smaller than 2 millimeters advantageously helps provide smaller more finely sized starch-containing particles 38 that more rapidly provide plant or flora beneficial support upon being used, e.g., applied.

In one such preferred embodiment, such plant or flora supporting media 30 of the present invention has at least a plurality, preferably at least a plurality of pairs, i.e. at least three, of extruded plant or flora supporting granules 32 per cubic centimeter of the package media 30 each being an extruded pellet 36 each having a size no smaller than 2 millimeters such that each pellet 36 being larger in size thereby advantageously contains more starch, preferably a sufficient amount or mass of starch in a larger sized starch matrix from such a larger sized pellet 36, such that the starch from each pellet 36 is released more slowly, preferably at least over a duration of time of at least a plurality of pairs, i.e. at least three days, preferably over a duration of time of at least one week, and more preferably over a duration of time of at least a plurality, preferably a plurality of pairs, of weeks after ground application advantageously providing beneficial plant support longer. In such a preferred embodiment, such plant or flora supporting media 30 of the present invention has at least a plurality, preferably at least a plurality of pairs, i.e. at least three, of extruded plant or flora supporting granules 32 per cubic centimeter of the package media 30 each being a smaller sized fine 36 each having a size smaller than 2 millimeters such that each fine 36 more rapidly releases its starch in providing beneficial plant support preferably over a duration of time of no more than a week and preferably no more than about three days following ground application.

In a preferred embodiment, one or more of the extruded pellets 36a and/or 36b of granular plant supporting media of the present invention are impregnated, coated or otherwise treated with nitrogen fixing bacteria, preferably free living nitrogen fixing bacteria, such as one or more of clostridium, klebsiella, rhodobacter, nostoc, and/or azotobacter, in a form which activate or become activated when the pellets 36a and/or 36b are wetted with water or another aqueous solution. If desired, all of the extruded pellets 36a and/or 36b and fines 36 can be so treated. In another preferred embodiment, one or more pellets of the granular plant supporting media are impregnated, coated or otherwise treated with symbiotic nitrogen fixing bacteria, such as one or more of rhizobium and/or azospirillum, depending on the nature of the seeds and/or plant media to be nourished with nitrogen produced from such symbiotic nitrogen fixing bacteria. If desired, all of the extruded pellets 36a and/or 36b and fines 36 can be so treated.

With regard to one preferred type of plant or flora supporting pellet of the present invention, pellet 36a differs from elongate generally oblong, e.g. generally cylindrical, pellet 36b as pellet 36a is a splayed pellet 60 having one or more elongate lobes 62 projecting outwardly from the pellet body 56 which are each narrower in width than the pellet body 56 that not only increase pellet surface area but which also facilitate engagement with one or more other plant or flora supporting pellets, e.g. pellets 36a and/or 36b, including during ground application. Such a pellet engaging or coupling lobes 62 advantageously help facilitate engagement and binding of pellets and particles together during ground application wetting helping to produce a stronger more tightly bound together plant or flora supporting mass after ground application wetting is finished.

Although not shown in FIG. 2, one or more pellets 36a that is a splayed pellet 60 can also be fibrillated having one or more elongate fibrils or tendrils each narrower than lobes 62 and which each preferably have a length no greater than 1000 microns and a width no greater than 1000 microns. Where such a pellet 36a also is fibrillated, the fibrils or tendrils advantageously help not only facilitate pellet, granule and/or particle engagement during ground application watering, but also function as liquid wicks that each facilitate more rapid and better water uptake during ground application watering.

In a preferred embodiment of a pellet 36a that is a splayed pellet 60, which also can be fibrillated, pellet 36a can and preferably does also have at least some of the interior starch matrix 58 exposed as a result of the splaying process used to produce splayed pellet 60. As a result of the splaying process exposing at least some of the interior starch matrix 58 of each splayed pellet 60, at least one, preferably at least a plurality, and more preferably at least a plurality of pairs, i.e. at least three, of the internal voids or pockets 64 that were previously covered by or in compass within outer pellet surface 42 are also exposed helping to not only facilitate water absorption during ground application watering but also helping to facilitate more rapid water absorption during ground application watering.

As previously indicated, each pellet 36a and 36b is preferably porous having at least a plurality, preferably at least a plurality of pairs, i.e. at least three, of pores 40 formed in the outer surface 42 of each pellet 36a and 36b with each pellet 36a and 36b also preferably having at least a plurality, preferably at least a plurality of pairs, i.e. at least three, of internal voids and/or pockets 64 (pellet 36a) within the starch matrix of the pellet body of each pellet 36a and 36b. At least one of the pores 40 of pellets 36a and 36b preferably is in fluid flow communication with one or more of the internal voids or pockets within the pellet body thereby facilitating uptake of water, preferably providing an increased rate of water uptake, into each pellet 36a and 36b during ground application and/or watering.

As a result of the modification of starches that occurs from and/or during pellet extrusion, including physical and/or thermodynamic modification of such starches, at least a portion of the starch matrix 58 as well as the outer surface or skin 42 of each pellet 36a and 36b are not only water soluble, including that portion which forms water soluble binder in both the matrix 58 and outer surface 42, but which also deforms and/or collapses when wetted with water in a manner that facilitates water retention after water uptake. As a result, the initial shape or form of each pellet 36a and 36b prior to application of water, including during or after ground application and/or ground watering, deforms during application of water including by collapsing in a manner that either flattens or spreads out each wetted pellet 36a and 36b and/or compacts and/or densifies each wetted pellet 36a and 36b. Such a pellet collapsing deformation that results from application of water during or after ground application of granular plant or flora supporting media 30 containing such pellets 36a and 36b not only flattens out or compacts the pellets 36a and 36b but preferably also densifies them preventing them from blowing away as well as helping to ground anchor the resultant agglomerated plant or flora supporting mass formed by pellets 36a and/or 36b, extruded particles 38 and/or non-extruded granules 44, e.g., non-extruded particles 46, 48 and/or 50, of the granular plant or flora supporting media 30 binding and/or melting together during or from ground application watering.

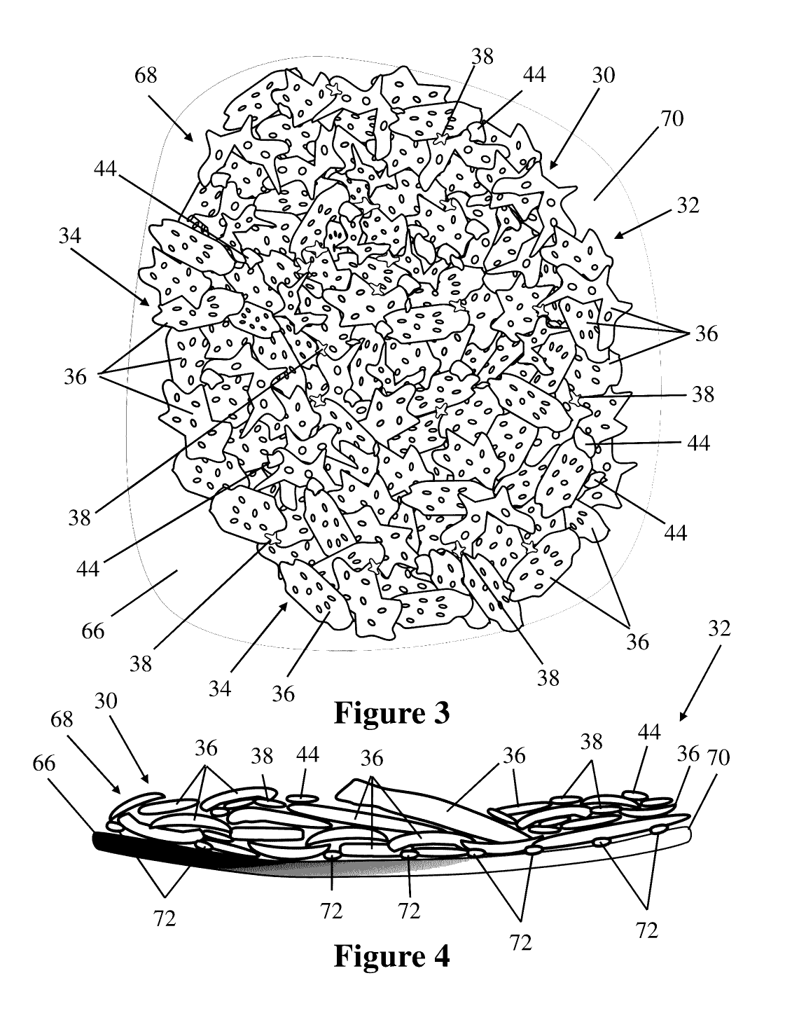

FIGS. 3 and 4 illustrate ground or soil application of extruded granular plant or flora supporting media 30 where one or more layers, preferably at least a plurality of layers, of plant or flora supporting granules 34, each including at least a plurality of pairs, i.e. at least three, of extruded plant or flora supporting pellets 36, e.g., pellets 36a and/or pellets 36b, are applied on the ground 66 depicted by the accumulated mass 68 of the granules 34 shown in FIGS. 3 and 4. Granular plant or flora supporting media 30 of the present invention can be and is intended to be applied directly on exposed soil 70 as well as onto, on top of, and/or around one or more plants (not shown) including plants germinated from seeds which have not yet broken through the soil, plants extending upwardly from the soil through and/or above the granular plant or flora supporting media mass 68, and can also be used as a soil preparation applied onto the ground, e.g. exposed soil, at least a plurality, preferably at least a plurality of pairs, i.e. at least three, of days prior to planting. Granular plant or flora supporting media 30 of the present invention can be and preferably also is intended to be applied directly on ground 66, including on exposed soil 70, in which flora, such as in the form of seedlings, saplings, sprouts, shoots or the like have been planted to preferably facilitate and speed germination and/or growth thereof.

In addition, granular plant or flora supporting media 30 of the present invention can be mixed with planting soil, potting soil, peat moss or another type of growth medium used in planting or supporting plant growth including by pre-packaging such granular plant or flora supporting media 30 therewith for retail, e.g. consumer, or commercial sale or use. In one preferred embodiment of a planting soil or potting soil formulation or mixture of the present invention, the soil formulation or mixture contains at least 10% granular plant or flora supporting media 30 by total weight of the planting soil or potting soil formulation. Such a preferred planting soil or potting soil mixture can and preferably does also contain at least 10% peat moss by total weight of the planting soil or potting soil formulation. In another preferred planting soil or potting soil formulation or mixture, the soil formulation or mixture contains at least 25% granular plant or flora supporting media 30 by total weight of the planting soil or potting soil formulation. Such a preferred planting soil or potting soil mixture can and preferably does also contain at least 15% peat moss by total weight of the planting soil or potting soil formulation.

Where mixed with peat moss, a preferred peat moss and granular plant or flora supporting media mixture or formulation of the present invention preferably contains at least 10%, preferably at least 15%, and more preferably at least 20% extruded granular plant or flora supporting media 30 and at least 50% peat moss by total weight of the formulation or mixture. In one preferred mixture or formulation, the people moss and granular plant or flora supporting meteor mixture or formulation contains equal amounts of extruded granular plant or flora supporting media 30 and peat moss with each being present in an amount of at least 35% by total weight of the formulation or mixture.

As discussed in more detail below, granular plant or flora supporting media 30 of the present invention can also be and preferably also is intended to be applied directly on ground 66, including on exposed soil 70, in which seeds have been planted with such media 30 advantageously helping to facilitate germination of the seeds as well as to beneficially support growth of the plants that germinate from the seeds for at least a plurality, preferably at least a plurality of pairs, i.e., at least, three days after germination.

In one preferred extruded granular plant or flora supporting media use or application, extruded granular plant or flora supporting media 30 is applied onto turf, e.g. grass, as a turf care product that preferably is a grass supporting and/or treating media that provides food for grass growth, fertilizer for grass growth, treatment for improved grass health, and/or the like. In one preferred extruded granular plant or flora media use or application, extruded granular plant or flora supporting media 30 is applied around plants, e.g. houseplants, bushes, trees and the like to support and/or treat the plants, bushes and/or trees in a similar manner that helps facilitate their growth, improves their health and/or the like.

In supporting such growth and/or improved health, starch in the extruded granules of the media 30, including extruded pellets 36, provides growth medium for facilitating growth of beneficial bacteria, including nitrogen and other fertilizer releasing bacteria, and which can also provide growth medium for facilitating growth of beneficial inoculants, e.g. fungi. In one preferred embodiment of extruded granular plant or flora supporting media 30 of the present invention, the media 30 preferably includes one or more granules or particles containing one or more types or strains of such plant beneficial bacteria and/or one or more granules or particles containing one or more types or fungal strains of such plant beneficial inoculants. In one such preferred embodiment, such granules or particles of the media 30 can be provided by extruded pellets 36 and/or extruded particles 38 which have been treated prior to ground application with one or more such types of plant beneficial bacteria and/or one or more such types of plant beneficial inoculants.

In a preferred method of making plant beneficial bacteria containing extruded granular plant or flora supporting media 30 in accordance with the present invention, one or more types of plant beneficial bacteria are mixed into or otherwise provided in the admixture from which the plant or flora supporting pellets 36 are extruded thereby distributing and/or encapsulating the plant beneficial bacteria in the starch matrix of each one of the beneficial plant bacteria containing pellets 36. Starch in the matrix of each extruded beneficial plant bacteria containing pellet 36 not only provides bacterial growth medium that nourishes and facilitates growth of the bacteria upon ground application, but also helps keep a greater number of the bacteria in each such pellet 36 alive when dormant prior to ground application by also helping nourish and feed the bacteria.

In another preferred method of making plant beneficial bacteria containing extruded granular plant or flora supporting media 30 in accordance with the present invention, plant or flora supporting pellets 36 are treated with a liquid, such as water, containing one or more types of such plant beneficial bacteria that is sprayed onto the pellets 36 during or after extrusion, such as prior to and/or during packaging of the media 30. In still another preferred method of making plant beneficial bacteria containing extruded granular plant or flora supporting media 30 in accordance with the present invention, plant or flora supporting pellets 36 are treated with a dry material, such as powder, e.g., freeze-dried powder, containing one or more types of such plant beneficial bacteria by applying the dry beneficial bacteria containing material, e.g. beneficial bacteria containing powder, onto the pellets 36 during or after extrusion, including while the pellets 36 are still moist and/or tacky after extrusion, but which can also be applied during packaging if desired. Where applied during packaging, the dry beneficial bacteria containing material can be added to the media 30 during packaging, put in each package prior to media packaging, and/or added in another manner, e.g. via dusting, prior to and/or during packaging of the media 34 retail, e.g. consumer, and/or commercial/industrial use or consumption.

In a preferred method of making plant beneficial inoculant containing extruded granular plant or flora supporting media 30 in accordance with the present invention, one or more types of plant beneficial inoculants are mixed into or otherwise provided in the admixture from which the plant or flora supporting pellets 36 are extruded thereby distributing and/or encapsulating the plant beneficial inoculants in the starch matrix of each one of the beneficial plant inoculant containing pellets 36. Starch in the matrix of each extruded beneficial plant inoculant containing pellet 36 not only provides growth medium that nourishes and facilitates inoculant growth upon ground application, but also can advantageously help maintain them in a live or usable condition while in a dormant state prior to ground application that are capable of being activated including upon ground application.

In another preferred method of making plant beneficial inoculant containing extruded granular plant or flora supporting media 30 in accordance with the present invention, plant or flora supporting pellets 36 are treated with a liquid, such as water, containing one or more types of such plant beneficial inoculants sprayed onto the pellets 36 during or after extrusion, such as prior to and/or during packaging of the media 30. In still another preferred method of making plant beneficial inoculant containing extruded granular plant or flora supporting media 30 in accordance with the present invention, plant or flora supporting pellets 36 are treated with a dry material, such as powder, e.g., freeze-dried powder, containing one or more fungal strains of such plant beneficial inoculants by applying the dry beneficial inoculant containing material, e.g. beneficial inoculant containing powder, onto the pellets 36 during or after extrusion, including while the pellets 36 are still moist and/or tacky immediately upon extrusion, but which can also be applied during packaging if desired. Where applied during packaging, the dry beneficial inoculant containing material, e.g. inoculant containing powder, can be added to the media 30 during packaging, put in each package prior to media packaging, and/or added in another manner, e.g. via dusting, prior to and/or during packaging of the media 34 retail, e.g. consumer, and/or commercial/industrial use or consumption.

With continued reference to FIGS. 3 and 4, extruded pellets 36, extruded fines 38, and/or any other non-extruded granules 40, e.g. non-extruded particles 46, 48 and/or 50 (FIG. 1) of granular plant or flora supporting media 30 are shown applied onto soil 70 on or in which at least a plurality of pairs of seeds 72 (FIG. 4) have been spread or otherwise planted. The extruded pellets 36, extruded fines 38, and/or non-extruded granules 40 of the media 30 preferably substantially completely cover at least a plurality, preferably at least a plurality of pairs, i.e. at least three, of the seeds 72 as shown in FIG. 4.

In a preferred embodiment, spreading or planting of the seeds 72 is done in a separate prior step to the step of applying the granular plant or flora supporting media 30 on the ground 66, including on any exposed soil 70, covering the seeds 72, where spread on top of the ground 66 or soil 70, and/or covering soil 70 on top of any such seeds 72, where the seeds 72 have been planted in the ground 66 by inserting them into the soil 70 to a depth below the top surface of the soil 70. In one preferred embodiment of a granular plant or flora supporting media 30 formulated or otherwise mixed in accordance with the present invention, the media 30 can include at least a plurality, preferably at least a plurality of pairs, i.e. at least three, of seeds 72 per cubic inch of volume of such a resultant seed-containing granular plant or flora supporting media 30 of the invention. Depending upon the size of the seeds 72 mixed with the extruded pellets 36, e.g., pellets 36a and/or 36b, of the media 30 and/or any extruded fines 38 and/or any non-extruded granules 40, e.g., non-extruded particles 46, 48 and/or 50, in formulating or otherwise mixing such a seed-containing granular plant or flora supporting media 30, such a media mixture or formulation can and preferably does contain at least a plurality, preferably at least a plurality of pairs, i.e. at least three, of the seeds 72 per cubic centimeter volume of such a seed-containing media 30 of the present invention. Where such a granular plant or flora supporting media 30 of the present invention includes seeds 72 in its mixture or formulation, such a seed-containing media 30 of the present invention preferably applies both the seeds 72 and plant or flora supporting granules, including at least extruded pellets 36, substantially in unison in a single step during application of the seed-containing media 30 on the ground 66.

While it is contemplated that the media 30 can be applied on the ground 66 in its substantially dry prepackaged form where the media 30 preferably has a moisture content of no more than 12% by weight, preferably no more than 10% by weight, and more preferably no more than 8% by weight, the applied mass 68 of extruded pellets 36, fines 38 and/or any non-extruded granules 40, as well as any seeds 72 included in the mixture of the media 30, preferably is watered during and/or after media application.

In a preferred method of plant or flora supporting media application and use, a moisturizing or watering step is performed before ground application of the media 30 where a liquid, preferably water or a liquid containing water, is applied, e.g. sprayed, onto or over the area onto which the media 30 is going to be applied. In such a preferred method of application and use where seeds 72 are spread or otherwise planted before ground application of the media 30, such a moisturizing or watering step can be and preferably is performed before applying the media 30 over the area containing the seeds 72. In one such preferred method of application and use, a moisturizing or watering step is performed after application of the media 30 over the area containing the seeds 72.

In another preferred method of application and use, a pre-moisturizing or pre-watering step can be performed where a liquid, preferably water or a liquid containing water, is applied, e.g. sprayed, onto or over the area of the ground 70 onto which the media 30 is going to be applied before the media 30 is actually applied. In such a preferred method, including where the seeds 72 are spread over or planted in the ground 66 prior to application of the media 30, such a pre-moisturizing or pre-watering step can also be performed before the seeds 72 are spread over or planted in the ground 66. In one such preferred method, another moisturizing or watering step can be performed after ground application of the media 30. If desired, a first moisturizing or watering step is performed after the seeds 72 are spread over or otherwise planted in the ground 66 and a second moisturizing or watering step is performed after ground application of the media 30. Where the media 30 is seed-containing media that also includes seeds 72, in a further preferred method of application and use, a pre-moisturizing or pre-watering step can be and preferably is performed by applying, e.g., spraying or misting, liquid, preferably water or which contains water, over or onto the area or portion of the ground 70 onto or over which the seed-containing media 30 is going to be spread before a subsequent post application moisturizing or watering step is performed by applying, e.g., spraying or misting, liquid, preferably water or which contains water, over or onto the area or portion of the ground onto or over which the seed-containing media 30 has been spread.

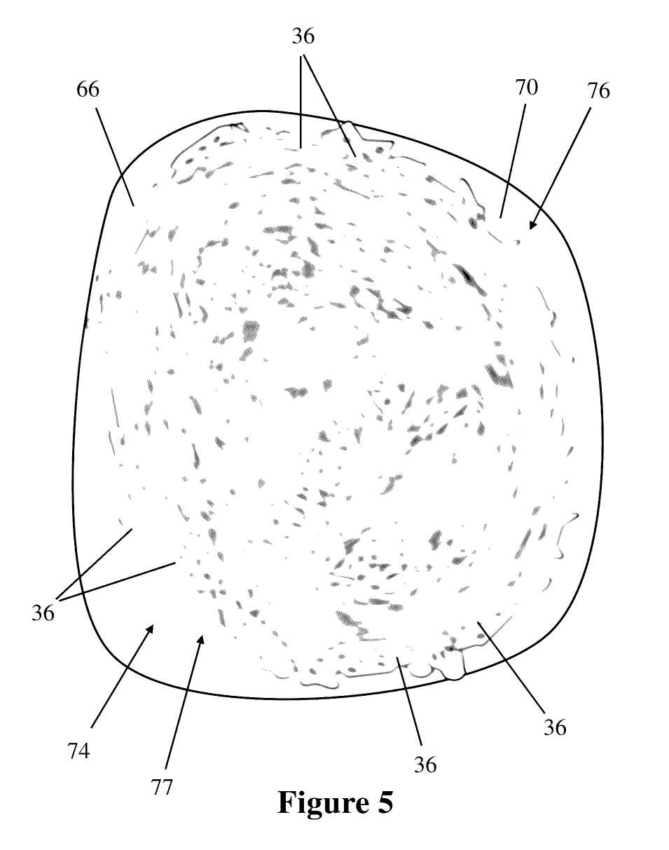

FIG. 5 depicts an agglomerated wetted mass 74 that forms from the applied dry mass 68 of granules 34 of the granular plant and flora supporting media 30 of the present invention after applying liquid, preferably water or a water containing liquid, thereto or thereon in an application or post application moisturizing or watering step. As also shown in FIG. 5, when water is applied on the one or more layers of extruded pellets 36, e.g., pellets 36a and/or 36b, of the granular plant and flora supporting media 30 of the present invention, at least some solubilizing of starch in the starch matrix of one or more of the extruded pellets 36 occurs releasing at least some dissolved starch that flows from the wetted pellets 36 which becomes available substantially immediately to help facilitate and/or seed germination and/or plant growth. At least some of this starch that dissolves from each wetted pellet 36 preferably includes water soluble binder, preferably cold water soluble binder, more preferably amylopectin cold water soluble binder, which at least makes each wetted pellet 36 at least somewhat tacky or sticky causing each wetted pellet 36 to adhere to one or more adjacent pellets 36, extruded fines 38 and/or non-extruded granules 40, where such fines 38 and/or non-extruded granules 40 are present in the media 30. As water is applied onto the pellets 36 and/or fines 38 of the media 30 causing starch, including water soluble binder, to become solubilized, the pellets 36 and/or fines 38 at least partially melt and/or collapse merging with one another and encapsulating any seeds 72 and/or non-extruded granules 40 forming such a wetted agglomerated covering mass 74 where many of the pellets 36 and/or fines 38 become indistinguishable from one another.

In a preferred granular plant and flora supporting media embodiment, wetting of the extruded pellets 36 of the media 30 solubilizes water soluble binder, e.g. cold water soluble binder, formed of or from starch during pellet extrusion producing at least some flowable adhesive that flows from, around and/or in between other pellets 36, fines 38 and/or non-extruded granules 40 as well as any seeds 72 coming in contact therewith forming an agglomerated plant or flora supporting and covering mass 74 that substantially completely covers and/or encapsulates the ground 66, e.g. soil 70, onto which the media 30 was originally applied. In doing so at least some of the flowable adhesive and/or solubilized starch flows into the ground 66, e.g. soil 70, not only helping to anchor the agglomerated covering mass 74 but also providing starch, e.g. food, to nourish fertilizer producing bacteria in the soil. Where some of the flowable adhesive from the wetted pellets flows onto and into the ground 66, the flowable adhesive can also help anchor the wetted agglomerated covering mass 74 thereto helping to prevent it from lifting and/or being blown away. This anchoring affect can continue even after the wetted agglomerated covering mass 74 dries sufficiently enough to become a substantially solid covering mass 76 that preferably is of one-piece substantially homogeneous construction.

Application of water to the granular plant or flora supporting media 30 also causes each one of the wetted pellets 36 and/or fines 38 to absorb water at least some of which is retained during adherence of the granules 34 of the media 30 together, preferably via clumping action, which causes the granules 34 to become bound together forming a clump together agglomerated covering mass 74 that over time cures or hardens to become one substantially solid ground or seed covering mass 76. This retained water is trapped in the resultant substantially solid covering mass 76 and is only slowly released therefrom into the area surrounding the mass 76 over at least a plurality, preferably at least a plurality of pairs, i.e. at least three, days thereby advantageously providing see germinating moisture to seeds 72 and/or plant supporting moisture to growing plants in contact therewith. In addition, the substantially solid covering mass 76 that results upon sufficient drying of the wetted agglomerated covering mass 74 advantageously acts as a moisture evaporation covering overlying the ground 66, e.g. soil 70, helping to keep the ground 66, e.g. soil 70, moist and also reduce the rate of evaporation therefrom. This helps keep seeds 72 and/or plants covered and/or encapsulated thereby in contact or more constant contact with moisture, preferably a greater amount of moisture than if the media 30 was not applied advantageously promoting seed germination and increasing plant growth. In addition to releasing, e.g., dispensing moisture, to seeds 72 underlying and/or encapsulated within the substantially solid covering mass 76 to facilitate seed germination and acting as a moisture evaporation prevention covering, the substantially solid covering mass 76 also advantageously provides a protective layer or covering to the seeds 72 and/or the roots of any plants covered thereby.

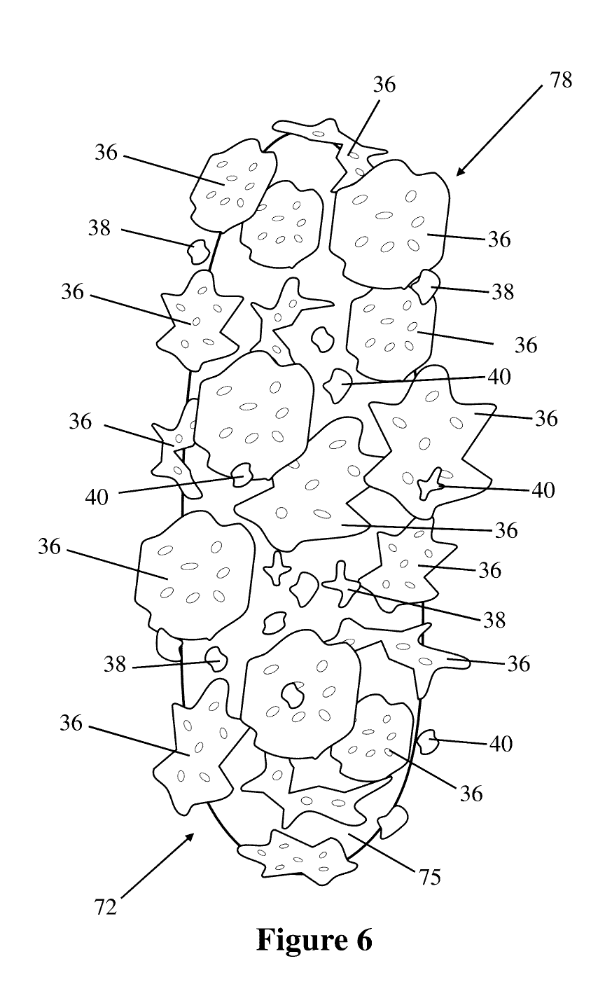

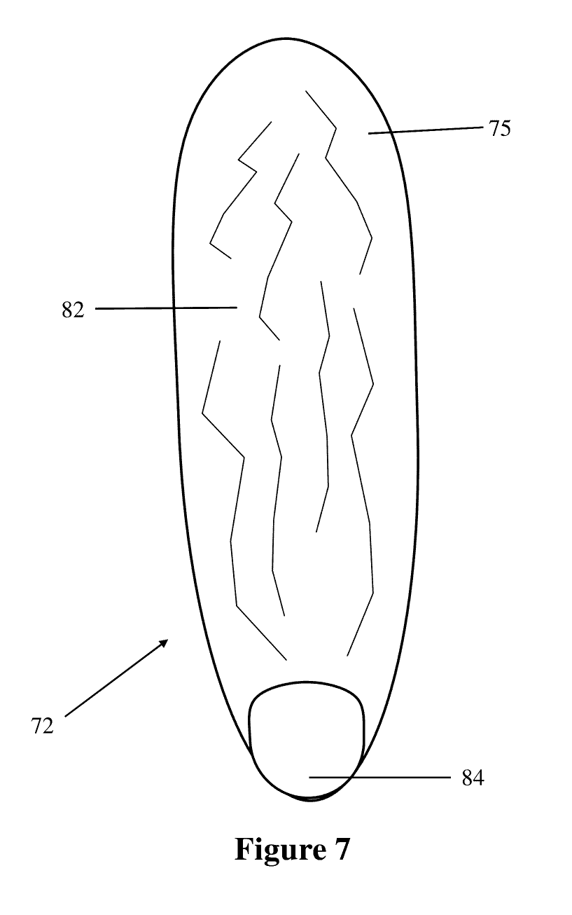

FIG. 6 illustrates a preferred embodiment of a seed carrying germination initiating and growth supporting granule 78 of the present invention that includes at least one seed 72, such as the uncoated or uncovered bare seed 72 shown in FIG. 7, which is coated and/or covered by one or more, preferably by at least a plurality, preferably at least a plurality of pairs, i.e. at least three, extruded pellets 36, e.g. pellets 36a and/or 36b, at least lightly adhered thereto by a binder that preferably is the water-soluble binder, preferably cold water soluble binder, more preferably amylopectin cold water-soluble binder, formed from starch in the admixture in each pellet 36 and/or fine 38 during extrusion. The seed 72 of such a preferred seed carrying germination initiating and growth supporting granule 78 can and preferably does also include at least a plurality, preferably at least a plurality of pairs, i.e. at least three, of extruded fines 38 also adhered to the outer surface 75 of the seed 72. If desired, such a preferred seed carrying germination initiating and growth supporting granule 78 of the present invention can also include a plurality, preferably at least a plurality of pairs, i.e. at least three, of the aforementioned non-extruded granules 40, including any one or more of non-extruded particles 46, 48 and/or 50 discussed above.

The seed 72 shown in FIG. 7 that is coated or covered with extruded pellets 36 and/or extruded fines 38, can be and preferably is an elongate grass or grain seed 80 having an outer hull 82 covering an inner endosperm, and embryo or germ 84 which can be, for example, a ryegrass seed, wheat seed, rice seed, hayseed or the like but which also can be a seed of any kind, including that of a bean seed, corn seed, pea, grass seed, or the like. In a preferred seed carrying germination initiating and plant growth supporting granule 78 of the present invention, each one of the seeds 72 preferably is substantially completely coated and/or covered by extruded pellets 36 and/or extruded fines 38. Each of the starch-containing pellets 36 and/or fines 38 attached to the seed 72 advantageously not only helps absorb and more controllably, preferably more slowly, release moisture over time to help germinate the seed 72 but which also breaks down or biodegrades in a manner that releases food or continues to release food thereafter, e.g. after the moisture release phase is finished, which advantageously helps nourish any plant that ultimately grows from or out of the germinated seed 72.

During application of pellets 36, fines 38 and/or non-extruded granules 40 in making each seed carrying germination initiating and plant growth supporting granule 78, the pellets 36 fines 38 and/or non-extruded granules 40 are applied to each seed 72 that is coated prior to application with an adhesive, preferably the water soluble binder, e.g., cold water soluble binder, produced in extruded pellets 36 which can either come from wetted pellets 36 during seed application or which can have been separated from other extruded pellets 36 in an adhesive separation process. As such, in addition to having such extruded pellets 36, extruded fines 38 and/or non-extruded granules 40 preferably firmly adhesively attached to the outer surface 75 of each seed 72 treated to form such a seed carrying germination initiating and plant growth supporting granule 78 of the present invention, each seed 72 preferably is substantially completely coated with starch based water soluble binder, preferably starch-based cold water soluble binder, more preferably amylopectin cold water soluble binder.

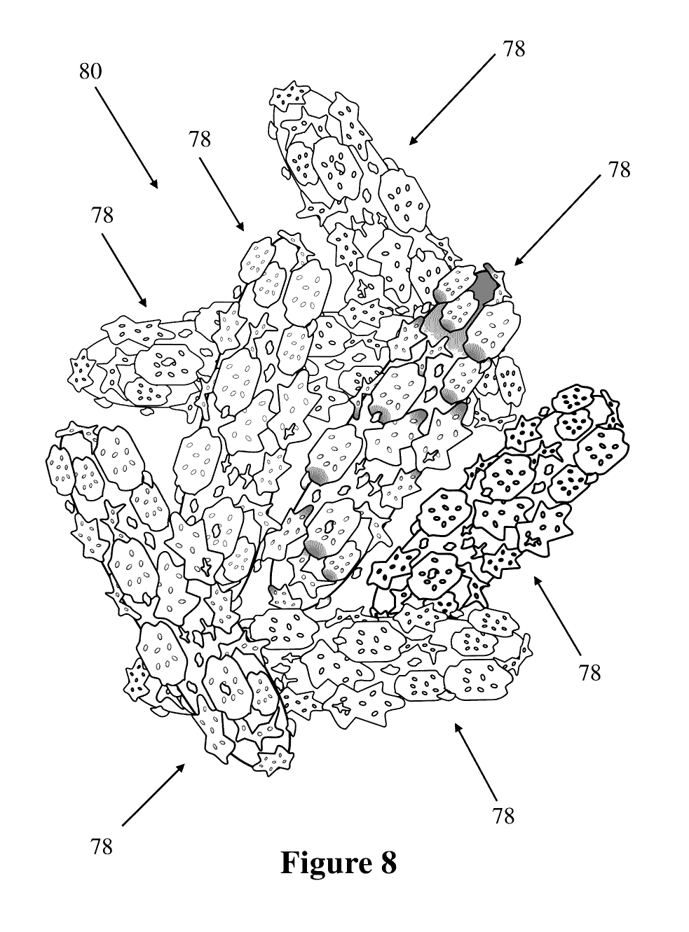

FIG. 8 illustrates seeds 72 after treatment of each to form a seed carrying germination initiating and plant growth supporting granule 78 of the present invention producing a batch 80 containing at least a plurality of pairs, i.e. at least three, granule 78 which have been dried and are ready to plant in the ground 66 and/or otherwise spread on the ground 66. While such a batch 80 of seed carrying granules 78 can be made, packaged and/or stored in bulk, the seed carrying granules 78 can also be mixed with aforementioned plant or flora supporting granules 34, including pellets 36, fines 38 and/or non-extruded granules 40, e.g., non-extruded plant or flora treatment particles 46, 48 and/or 50, producing such a preferred mixture or formulation of a preferred embodiment of a seed carrying granular plant or flora supporting media 30 of the invention. Where a batch of such seed carrying granules 78 are mixed with such plant or flora supporting granules 34 to produce such a preferred seed carrying plant or flora supporting media embodiment, the resultant seed carrying plant or flora supporting media 30 can be and preferably is applied in the same manner as the plant or flora supporting media 30 discussed above. This includes application of moisture and/or water before, during, e.g. with, and/or after ground application of such seed carrying granular plant or flora supporting media 30 of the present invention containing such seed carrying granules 78 of the present invention.

The present invention is therefore directed to seed and/or plant supporting granular media 30 formed of granules or pellets 36 that preferably are extruded from a starch-containing mixture, e.g. admixture, producing such extruded starch-containing granules or pellets 36 that can be used by themselves to support seeds and/or plants, but which also can each carry one or more seeds 72 producing seed carrying granules or pellets 78 that can be applied on the ground 66 or inserted into the ground 66 during planting. Each extruded starch-containing granule or pellet 36 preferably includes or is composed of a plurality of different types of seed germination initiating and/or plant supporting materials that differ by acting at a different rate, by providing a different type of support, and/or which can also differ in structure and/or composition. Each granule or pellet 36 has one type of material discussed in more detail below that is water soluble that dissolves or solubilizes when wetted with water or a liquid containing water. Such water soluble material preferably is starch-based and/or starch containing water soluble material that preferably includes water soluble material in the form of a water soluble binder or adhesive, which not only can facilitate seed attachment, but also can also be advantageous after application by flowing from wetted extruded pellets 36. By some of each wetted pellet 36 dissolving and flowing from the pellet 36 when wetted, each pellet 36 can be activated by exposing or otherwise releasing material left behind within the pellet 36. In addition, the water soluble material that dissolved and flowed from each pellet 36 can help support the seeds and/or plants in a manner different than what remains from or of each wetted pellet 36 after the water soluble material has flowed therefrom. Where the pellets 36 are spread on the ground 66 in close proximity to one another, wetting of the pellets 36 can cause a plurality of pairs of pellets 36 to join together forming an agglomerated mass 74 of the pellets 36 that can produce a mulch clump 77 providing further beneficial seed and/or plant support.

Extruded pellets 36 of such seed germinating and/or plant supporting granular media 30 of the present invention can be used alone to support germination, sprouting, growth and/or health of seeds, e.g., seeds 72, and/or plants when applied to, on and/or around seeds, e.g., seeds 72, and/or plants that have previously been planted. Extruded pellets 36 of such seed germinating and/or plant supporting granular media of the present invention can also be used as a seed distributing or seed distribution agent where pellets 36 each carrying one or more seeds 72 and/or seeds 72 carrying one or more pellets 36 are planted by distributing the seed-carrying granules 78 on the ground or even by inserting the seed-carrying granules 78 in the ground.

Where used for aquaculture applications, extruded pellets 36 of seed and/or plant supporting granular media 30 of the present invention can be used alone to support germination, sprouting, growth and/or health of seeds and/or aquatic plants when applied in the water to, on and/or around seeds and/or plants that have previously been planted. Extruded pellets 36 of seed and/or plant supporting granular media 30 of the present invention can also be used as a seed distributing or seed distribution agent where granules 78 composed of a seed 72 carrying more than one extruded pellet 36 or pellets 36 each carrying more than one seed 72 are planted by distributing the seed-carrying granules 78 in or on the water or even by inserting the seed-carrying granules 78 in the ground, e.g. pond bottom, lake bottom, stream bottom and/or river bottom, under the surface of the water. It is also contemplated that extruded pellets 36 of seed and/or plant supporting granular media of the present invention can be similarly used standalone and/or as a seed distribution agent in blogs, marshes, cranberry beds, and the like.

In a presently preferred seed and/or plant supporting granular media embodiment, extruded pellets 36 can be and preferably are used as a bulking agent and/or distribution agent for seeding applications and are particularly well suited for distributing light seed or fine seed like grass seed, carrot seed, onion seed and other types of light seeds and/or other fine seeds typically having at least 150 seeds per gram. In addition to the water-soluble material of each extruded starch-containing pellet 36 providing a type of seed or plant supporting material that is different from water insoluble material also contained by each pellet 36, the water-soluble material of each pellet 36 includes starch-based water-soluble binder that is used in attaching and/or coating seeds 72, including as discussed in more detail below.

In a preferred seed and/or plant supporting granular media of the present invention, the seed and/or plant supporting granular media is at least partially composed of pellets 36 and/or fines 38 formed of a starch-containing admixture extruded from a single screw extruder or a twin screw extruder producing extruded pellets 36 and/or fines 38 having a first seed or plant supporting material that is water-soluble material that includes water-soluble binder or adhesive, and a second seed or plant supporting material that preferably is water insoluble that can include fiber, such as cellulose or cellulosic fiber, which preferably also includes cold water insoluble starch in the starch matrix of each pellet 36 and/or fine 38. In a method of making seed and/or plant supporting granular media in accordance with the present invention, the starch-containing admixture is formulated to form water-soluble material comprised of water-soluble binder in each extruded pellet 36 and/or fine(s) 38 when the starch-containing admixture is gelatinized and extruded from the extruder at a desirably high extruder pressure and at a desirably high extruder temperature.

In a preferred method and pellet embodiment, the admixture contains enough starch so that when the admixture is gelatinized and extruded from the extruder, each extruded pellet 36 contains a sufficient amount of water soluble starch-based binder such that at least a portion of the outer surface 42 of each extruded pellet 36 becomes tacky enough when wetted with water, e.g. liquid containing water, that one or more seeds 72 contacting the tacky outer pellet surface 42 sticks to the pellet 36 thereby facilitating secure seed attachment thereto. In one preferred method and pellet embodiment, the admixture contains enough starch so that when the admixture is gelatinized and extruded from the extruder, each extruded pellet 36 contains a sufficient amount of water soluble starch-based binder such that at least some of the binder dissolves and flows from the pellet 36 when wetted with water, e.g. liquid containing water.

In another preferred method and pellet embodiment, polyvinyl alcohol is used instead of water to facilitate adherence of extruded pellets 36, fines, non-extruded granules, and/or non-extruded particles to each seed 72. In one such preferred method and embodiment, polyvinyl alcohol is used without any water to attached at least a plurality of extruded pellets 36 to each seed 72, such as by applying polyvinyl alcohol to one or both the pellets 36 and seed(s) 72, immersing the pellets 36 and seed(s) in polyvinyl alcohol, e.g., in a polyvinyl alcohol bath, or the like.

Polyvinyl alcohol can also be used to facilitate adherence to a plurality of seeds 72 to a single extruded pellet 36. In one such preferred method and embodiment, polyvinyl alcohol is used without any water to attached at least a plurality of seeds 72, preferably a plurality of pairs, i.e., at least three, seeds 72 to each pellet 36, such as by applying polyvinyl alcohol to one or both the pellets 36 and seed(s) 72, immersing the pellets 36 and seed(s) 72 in polyvinyl alcohol, e.g., in a polyvinyl alcohol bath, or the like.

In another preferred method and pellet embodiment, polyvinyl alcohol is with water or an aqueous solution to facilitate adherence of extruded pellets 36, fines, non-extruded granules, and/or non-extruded particles to each seed 72. In one such preferred method and embodiment, polyvinyl alcohol is used with water or an aqueous solution to attached at least a plurality of extruded pellets 36 to each seed 72, such as by applying an aqueous solution containing polyvinyl alcohol to one or both the pellets 36 and seed(s) 72, immersing the pellets 36 and seed(s) in an aqueous solution containing polyvinyl alcohol, e.g., in an aqueous polyvinyl alcohol bath, or the like.

Polyvinyl alcohol can also be used to facilitate adherence to a plurality of seeds 72 to a single extruded pellet 36. In one such preferred method and embodiment, polyvinyl alcohol is used with water to attached at least a plurality of seeds 72, preferably a plurality of pairs, i.e., at least three, seeds 72 to each pellet 36, such as by applying an aqueous solution containing polyvinyl alcohol to one or both the pellets 36 and seed(s) 72, immersing the pellets 36 and seed(s) 72 in an aqueous solution containing polyvinyl alcohol, e.g., in an aqueous polyvinyl alcohol bath, or the like.

In another preferred method and pellet embodiment, polyvinyl acetate is used instead of water to facilitate adherence of extruded pellets 36, fines, non-extruded granules, and/or non-extruded particles to each seed 72. In one such preferred method and embodiment, polyvinyl acetate is used without any water to attached at least a plurality of extruded pellets 36 to each seed 72, such as by applying polyvinyl acetate to one or both the pellets 36 and seed(s) 72, immersing the pellets 36 and seed(s) in polyvinyl acetate, e.g., in a polyvinyl acetate bath, or the like.

Polyvinyl acetate can also be used to facilitate adherence to a plurality of seeds 72 to a single extruded pellet 36. In one such preferred method and embodiment, polyvinyl acetate is used without any water to attached at least a plurality of seeds 72, preferably a plurality of pairs, i.e., at least three, seeds 72 to each pellet 36, such as by applying polyvinyl acetate to one or both the pellets 36 and seed(s) 72, immersing the pellets 36 and seed(s) 72 in polyvinyl acetate, e.g., in a polyvinyl acetate bath, or the like.

In another preferred method and pellet embodiment, polyvinyl acetate is used with water or an aqueous solution to facilitate attachment of extruded pellets 36, fines, non-extruded granules, and/or non-extruded particles to each seed 72. In one such preferred method and embodiment, polyvinyl acetate is used with water or an aqueous solution to attached at least a plurality of extruded pellets 36 to each seed 72, such as by applying an aqueous solution containing polyvinyl acetate to one or both the pellets 36 and seed(s) 72, immersing the pellets 36 and seed(s) in an aqueous solution containing polyvinyl acetate, e.g., in an aqueous polyvinyl acetate bath, or the like.

In one preferred method and pellet embodiment, a starch-containing admixture is gelatinized by an extruder that extrudes pellets 36 each having such a sufficient amount of water soluble starch-based binder that is formed from starch in the admixture during extrusion without the presence of any binder additive in the admixture. In one such preferred method and pellet embodiment, a starch-containing admixture formed of one or more cereal grains that can be comminuted, such as by grinding, pulverizing or powdering, having at least 35% starch by dry admixture weight (before any water is added to the admixture) is gelatinized and extruded from an extruder at an extruder pressure of at least 700 pounds per square inch and at an extruder temperature of at least 100° C. producing extruded pellets each having at least 5% water-soluble binder by pellet weight. Cereal grains particularly well suited for use in the admixture include corn, such as in the form of corn meal, and sorghum, preferably used in whole grain form. Other cereal grains including rice, wheat, triticale, buckwheat and the like can also be used. The water soluble binder of each pellet can include or be formed of dextrin. Where the water soluble binder in each pellet 36 includes dextrin, each such dextrin-containing pellet has at least 0.1% dextrin by pellet weight and preferably has at least 1% dextrin by pellet weight.

In another such preferred method and pellet embodiment, such a starch-containing admixture formed of one or more cereal grains is gelatinized and extruded from an extruder at an extruder pressure of at least 800 pounds per square inch (PSI) and at an extruder temperature of at least 100° C. producing extruded pellets 36 each having at least 10% water-soluble binder by pellet weight. One preferred admixture extruded at the aforementioned minimum extruder pressure and temperature has at least 45% starch by dry admixture weight. Another preferred admixture extruded at the aforementioned minimum extruder pressure and temperature has at least 50% starch by dry admixture weight. A further preferred admixture extruded at the aforementioned minimum extruder pressure and temperature has at least 55% starch by dry admixture weight. In another preferred extrusion method, any one of the aforementioned admixtures is extruded at an extruder pressure of at least 1500 PSI and at an extruder pressure of at least 110° C. In still another preferred extrusion method, any one of the aforementioned admixtures is extruded at an extruder pressure of at least 2000 PSI and at an extruder pressure of at least 100° C. In still another preferred extrusion method, any one of the aforementioned admixtures is extruded at an extruder pressure of at least 2500 PSI and at an extruder pressure of at least 100° C.

In still another such preferred method and pellet embodiment, such a starch-containing admixture formed of one or more cereal grains is gelatinized and extruded from an extruder at an extruder pressure of at least 1500 pounds per square inch and at an extruder temperature of at least 100° C. producing extruded pellets 36 each having at least 15% water-soluble binder by pellet weight. One preferred admixture extruded at the aforementioned minimum extruder pressure and temperature has at least 45% starch by dry admixture weight. Another preferred admixture extruded at the aforementioned minimum extruder pressure and temperature has at least 50% starch by dry admixture weight. A further preferred admixture extruded at the aforementioned minimum extruder pressure and temperature has at least 55% starch by dry admixture weight. In another preferred extrusion method, any one of the aforementioned admixtures is extruded at an extruder pressure of at least 2000 PSI and at an extruder pressure of at least 110° C. In still another preferred extrusion method, any one of the aforementioned admixtures is extruded at an extruder pressure of at least 2500 PSI and at an extruder pressure of at least 100° C. In still another preferred extrusion method, any one of the aforementioned admixtures is extruded at an extruder pressure of at least 3000 PSI and at an extruder pressure of at least 100° C.

In a further such preferred method and pellet embodiment, such a starch-containing admixture formed of one or more cereal grains is gelatinized and extruded from an extruder at an extruder pressure of at least 1500 pounds per square inch and at an extruder temperature of at least 100° C. producing extruded pellets each having at least 25% water-soluble binder by pellet weight. One preferred admixture extruded at the aforementioned minimum extruder pressure and temperature has at least 45% starch by dry admixture weight. Another preferred admixture extruded at the aforementioned minimum extruder pressure and temperature has at least 50% starch by dry admixture weight. A further preferred admixture extruded at the aforementioned minimum extruder pressure and temperature has at least 55% starch by dry admixture weight. In another preferred extrusion method, any one of the aforementioned admixtures is extruded at an extruder pressure of at least 2000 PSI and at an extruder pressure of at least 110° C. In still another preferred extrusion method, any one of the aforementioned admixtures is extruded at an extruder pressure of at least 2500 PSI and at an extruder pressure of at least 100° C. In still another preferred extrusion method, any one of the aforementioned admixtures is extruded at an extruder pressure of at least 3000 PSI and at an extruder pressure of at least 100° C.

In a further such preferred method and pellet embodiment, such a starch-containing admixture formed of one or more cereal grains is gelatinized and extruded from an extruder at an extruder pressure of at least 1500 pounds per square inch and at an extruder temperature of at least 100° C. producing extruded pellets each having at least 35% water-soluble binder by pellet weight. The water soluble binder of each of these extruded pellets can include or be formed of dextrin. One preferred admixture extruded at the aforementioned minimum extruder pressure and temperature has at least 45% starch by dry admixture weight. Another preferred admixture extruded at the aforementioned minimum extruder pressure and temperature has at least 50% starch by dry admixture weight. A further preferred admixture extruded at the aforementioned minimum extruder pressure and temperature has at least 55% starch by dry admixture weight. In another preferred extrusion method, any one of the aforementioned admixtures is extruded at an extruder pressure of at least 2000 PSI and at an extruder pressure of at least 110° C. In still another preferred extrusion method, any one of the aforementioned admixtures is extruded at an extruder pressure of at least 2500 PSI and at an extruder pressure of at least 100° C. In still another preferred extrusion method, any one of the aforementioned admixtures is extruded at an extruder pressure of at least 3000 PSI and at an extruder pressure of at least 100° C. Extrusion at such a high extrusion pressure advantageously destroys any aflatoxin in the cereal grain(s) in the admixture used to extrude the pellets 36a and/or 36b.

In a further such preferred method and pellet embodiment, such a starch-containing admixture formed of one or more cereal grains is gelatinized and extruded from an extruder at an extruder pressure of at least 1500 pounds per square inch and at an extruder temperature of at least 100° C. producing extruded pellets 36 each having at least 45% water-soluble binder by pellet weight. One preferred admixture extruded at the aforementioned minimum extruder pressure and temperature has at least 45% starch by dry admixture weight. Another preferred admixture extruded at the aforementioned minimum extruder pressure and temperature has at least 50% starch by dry admixture weight. A further preferred admixture extruded at the aforementioned minimum extruder pressure and temperature has at least 55% starch by dry admixture weight. In another preferred extrusion method, any one of the aforementioned admixtures is extruded at an extruder pressure of at least 2000 PSI and at an extruder pressure of at least 110° C. In still another preferred extrusion method, any one of the aforementioned admixtures is extruded at an extruder pressure of at least 2500 PSI and at an extruder pressure of at least 100° C. In still another preferred extrusion method, any one of the aforementioned admixtures is extruded at an extruder pressure of at least 300 PSI and at an extruder pressure of at least 100° C.

The water soluble binder of the extruded pellets 36 can include or be formed of dextrin. Where the water soluble binder of each pellet includes dextrin, each such dextrin-containing pellet has at least 0.1% dextrin by pellet weight and preferably has at least 1% dextrin by pellet weight. In another preferred dextrin-containing pellet embodiment, each dextrin-containing pellet has at least 2% dextrin by pellet weight. In still another preferred dextrin-containing pellet embodiment, each dextrin-containing pellet has at least 5% dextrin by pellet weight. Where are an extruded pellet has a water-soluble binder content of 10% or greater and also contains dextrin, each dextrin-containing pellet can have a dextrin content of at least 7.5% dextrin by pellet weight.

In addition, such seed germination initiating and/or plant growth supporting pellets 36 of the present invention can also be extruded using any one of the admixtures, extruder operating parameters, and/or methods of extrusion disclosed in commonly owned U.S. application Ser. No. 13/842,534 can also be used with its publication, United States Patent Application Number US 2014/0069344 being hereby expressly incorporated by reference herein.

Each extruded pellet 36 preferably has a size ranging from as little as 0.25 mm to as much as 10 mm thereby varying in length, width and/or diameter between pellets or granules having a length, width and/or diameter of between 0.25 mm and 10 mm. Where used to carry seeds, the size of the pellets or granules preferably corresponds to the size of the seed or seeds attached with smaller pellets preferably being used to carry smaller seeds and larger pellets preferably being used to carry larger seeds. In at least one preferred embodiment, pellets having a length, width and/or diameter of between 0.75 mm and 2 mm are typically used to carry grass seed, carrot seed and other types of light or fine seeds. Where the pellets are intended for precision planting, each pellet preferably is elongate, e.g., generally cylindrical, facilitating precision planting including by enabling each pellet to be oriented/planted with its lengthwise direction extending generally vertically.

Each extruded pellet 36 also has a bulk density of at least 5 pounds per cubic foot and preferably has a bulk density of at least 10 pounds per cubic foot. Depending upon whether the extruded pellets or granules are going to be applied on the ground or inserted into the ground (or covered with soil), pellets or granules of seed and/or plant supporting granular media of the present invention preferably has a bulk density of at least 15 pounds per cubic foot. Where the extruded pellets or granules are going to be applied on top of the ground, the extruded pellets or granules can have an even greater bulk density. In one preferred embodiment, extruded pellets or granules intended for ground application have a bulk density of at least 20 pounds per cubic foot. In another such preferred embodiment, extruded pellets or granules intended for ground application have a bulk density of at least 25 pounds per cubic foot. In still another such preferred embodiment, extruded pellets or granules intended for ground application have a bulk density of at least 30 pounds per cubic foot.

Where the extruded pellets 36 are seed carrying and carry a light or fine seed such as grass seed, after seed attachment, the light/fine seed carrying pellets or granules preferably have a bulk density of at least 20 pounds per cubic foot. In another preferred embodiment, light/fine seed carrying extruded pellets or granules have a bulk density of at least 30 pounds per cubic foot. In still another preferred embodiment, light/fine seed carrying extruded pellets or granules have a bulk density of at least 40 pounds per cubic foot. In a further preferred embodiment, light/fine seed carrying extruded pellets or granules have a bulk density of at least 50 pounds per cubic foot.

The use of light/fine seed carrying pellets or granules, e.g., grass seed carrying pellets or granules, having such a greater bulk density advantageously helps promote more even distribution when being applied over a relatively large surface area of ground. The use of light/fine seed carrying pellets or granules having such a greater bulk density also helps to better anchor the seed carrying pellets or granules in place thereby better maintaining the more even distribution after being applied on the ground. This greater bulk density advantageously not only helps promote more uniform coverage during planting but also helps maintain the more uniform coverage afterwards preventing seeds from being blown around and/or clumping together as has commonly been the case in the past where seeds alone without anything else where applied. The end result of light seed carrying pellets or granules, e.g., grass seed carrying pellets or granules, having such a greater bulk density is that application coverage more uniform, it remains more uniform afterwards, and thereby advantageously produces plants grown from the seeds carried by the seed carrying pellets that more uniformly cover the desired area planted.

Such extruded pellets 36 of seed and/or plant supporting granular media formed or produced in accordance with the present invention possess enough water-soluble material containing enough water soluble binder to make at least a portion of the outer surface of each pellet tacky enough when wetted by water that one or more seeds will adhere thereto. Preferably, such extruded pellets of seed and/or plant supporting granular media formed or produced in accordance with the present invention contain enough water-soluble binder to not only make at least a portion of the outer surface of each wetted pellet tacky enough for one or more seeds to stick thereto but which also can flow therefrom as flowable starch-based adhesive. This flowable starch-based adhesive can be used not only to coat seeds, including during seed attachment, but also can form mulch clumps of adhesively joined together pellets after the pellets are applied on the ground as discussed in more detail below.

In a preferred embodiment, extruded pellets 36 of seed and/or plant supporting granular media of the present invention advantageously are wetted sufficiently with water or another liquid containing water to dissolve or otherwise solubilize enough of the starch based water soluble binder in each wetted pellet that at least some of the water soluble binder flows from the wetted pellets in the form of a starch-based flowable adhesive. The water soluble starch-based binder not only enables seeds to be attached directly to a wetted tacky surface of each wetted pellet but also enables the binder to flow from sufficiently wetted pellets in the form of flowable adhesive that can be and preferably is used to coat seeds. While the seeds can be used, e.g., spread or planted, after coating them with the flowable adhesive, coated seeds preferably are attached to extruded pellets using a seed attachment process where the coated seeds and extruded pellets are mixed together. Where coated seeds are used only after the coating step, each seed preferably is substantially completely coated by an outer layer of the flowable adhesive, e.g., starch-based water-soluble binder, during coating with the outer coating not only providing a layer of protection to each coated seed but also providing support thereto after planting helping to germinate, sprout and/or grow the seed.

The coated seeds 72 and extruded pellets 36 can be mixed together in a mixer, e.g., mixing tank, a blender, e.g. ribbon blender, or the like preferably while the coating of the coated seeds is still tacky enabling one or more coated seeds to be bonded or glued to each one of the pellets during mixing. In a preferred seed attachment method, coated seeds and extruded pellets are agglomerated in an agglomerator, such as a rotary drum agglomerator and/or pelletizer, in a manner that causes one or more coated seeds to adhere to each pellet. In one such preferred seed attachment method, the seeds are coated first before being mixed with extruded pellets in a plating or agglomerating step that causes one or more coated seeds to be attached to each one of at least a plurality of pairs of pellets. Preferably, at least one coated seed is attached to each pellet during seed attachment. After seed attachment, the seed carrying pellets are dried thereby firmly adhering each coated seeds attached to a pellet enabling the seed carrying pellets to be packaged and shipped for use.

Seed and/or plant supporting granular media formed of extruded granules or pellets in accordance with the present invention is well suited for seed distribution applications and is particularly well suited for light/fine seed distribution applications including, in particular, grass seed distribution applications. Types of grass seed well suited for application on the ground with extruded pellets or granules of seed and/or plant supporting granular media of the present invention include bluegrass, e.g., Kentucky Bluegrass, fescue, e.g., chewing(s) fescue, sheep fescue, strong creeping(s) fescue, and/or tall fescue, ryegrass, e.g., annual and/or perennial ryegrass, Bermuda grass, centipede grass and/or zoysia, e.g., zoysia japonica, as well as blends and/or combinations thereof.

Seed carrying granules or pellets 36 of seed and/or plant supporting granular media 30 used in light or fine seed distribution applications have granules or pellets that each preferably carry at least a plurality of pairs, i.e., at least 3, of light seeds. While such light/fine seed carrying granules or pellets of seed and/or plant supporting granular media can be planted by spreading them out over a relatively large area of ground, such as is the case where the light seed is grass seed, without applying any water at the time of planting, the light seed carrying granules or pellets preferably can be watered at the time of planting. In a preferred embodiment, light or fine seed carrying granules or pellets are applied using a stream of water that not only distributes the granules or pellets over a desired area of ground, the stream also waters the seeds carried by the pellets or granules helping to induce germination and/or sprouting of the seeds.

The use of such extruded seed carrying pellets enables seeding of a relatively large area thereby advantageously more uniformly distributing the seeds carried by the pellets over that area as compared to applying only the seeds over the same area. This is because attaching seeds to the much heavier pellets causes each seed carrying pellet to function as a “seed anchor” that is resistant to being blown around by the wind. In addition, by attaching seeds to pellets that are at least a plurality of pairs of times, i.e. at least 3 times, larger than the seed attached thereto application of a plurality of pairs of pounds of the seed carrying pellets over a plurality of pairs of square feet of ground surface area inherently more uniformly spreads the seed carrying pellets along the ground by helping to prevent stacking of pellets on top of one another.

In a preferred embodiment, each extruded pellet of seed and/or plant supporting granular media of the present invention has a size that is at least 10 times greater than the size of an average seed of the type of seed attached to the pellet thereby producing an inherently self-anchoring seed carrying pellet that better remains in place after being bulk applied on the ground. In one such preferred embodiment, each extruded pellet has a volume that is at least 10 times greater than the volume of an average seed of the type of seed attached to the pellet thereby producing an inherently self-anchoring seed carrying pellet that better remains in place after being bulk applied on the ground. In another such preferred embodiment, each extruded pellet has a weight that is at least 10 times greater than the weight of an average seed of the type of seed attached to the pellet thereby producing an inherently self-anchoring seed carrying pellet that better remains in place after being bulk applied on the ground. In still another such preferred embodiment, each extruded pellet has at least a plurality of a (a) size that is at least 10 times greater than the size of an average seed of the type of seed attached to the pellet, (b) volume that is at least 10 times greater than the volume of an average seed of the type of seed attached to the pellet, and/or (c) weight that is at least 10 times greater than the weight of an average seed of the type of seed attached to the pellet thereby producing an inherently self-anchoring seed carrying pellet that better remains in place after being bulk applied on the ground. In a further such preferred embodiment, each extruded pellet has at least a size that is at least 10 times greater than the size of an average seed of the type of seed attached to the pellet and a weight that is at least 10 times greater than the weight of an average seed of the type of seed attached to the pellet thereby producing an inherently self-anchoring seed carrying pellet that better remains in place after being bulk applied on the ground.

Where watering is done with or shortly after applying the seed carrying pellets on the ground, at least some water-soluble binder from each wetted pellet can flow therefrom as flowable adhesive in between adjacent seed carrying pellets binding them together forming clumps of at least a plurality of pairs of pellets that more stably remain in place thereafter as a result. In other words, wetting of the seed carrying pellets during or immediately after application forms “anchor” clumps containing at least a plurality of pairs of seed carrying pellets that remain in place because of their greater weight and larger contact surface area with the ground. Such an “anchor” clump preferably is formed by wetting of pellets causing adjacent pellets laying on the ground to be joined together forming a generally horizontally extending clump. Such horizontally extending clumps are each formed of seed carrying pellets having a plurality of pellets joined together in one direction and a plurality of pellets joined together in an opposite direction generally transverse to the one direction and are no more than a plurality of pairs of pellet layers thick (preferably no more than a plurality of pellets layers and more preferably no more than a single layer thick).

Even when not clump together, individual seed carrying pellets wetted during or immediately after application on the ground have flowable adhesive that flows from the pellets downwardly onto the ground as a result of gravity. This flowable adhesive not only can help treat the ground in and around, e.g., below, each seed carrying pellet in a manner that will help support seed germination, sprouting and/or subsequent plant growth, it also can dry and harden in a manner that helps prevent movement of the pellet along the ground. Such flowable adhesive flowing from seed carrying pellets not clumped together can form downwardly projecting stalactites or fingers that help anchor the pellet to the ground preventing the pellet from being blown around by the wind. In addition, depending upon what lies adjacent and/or below the seed carrying pellets, flowable adhesive flowing downwardly from pellets can cause one or more of the pellets to stick to a surface or object adjacent or below the pellet when the flowable adhesive dries also helping to anchor the pellet in place.

As a result, grass seeds applied on the ground together with extruded pellets of seed and/or plant supporting granular media that produces water-soluble flowable seed and/or plant supporting material that flows from pellets or granules and comprising a flowable adhesive has greater bulk and weight that enhances more even seed distribution during planting (particularly as compared to what actually adheres in place both by adherence to the ground and coverage via the extruded granular product and/or each other). Grass seeds adhered to extruded pellets of seed and/or plant supporting granular media comprising grass seed already adhered to the pellets or granules produces water-soluble flowable seed and/or plant supporting material that flows from grass seed coated pellets or granules producing flowable adhesive has greater bulk and weight significantly enhances more even seed distribution during planting.

Seed carrying or seed-adhered extruded pellets of seed and/or plant supporting granular media can have granules or pellets shaped to facilitate planting including by orienting one or more seeds attached to a pellet relative to gravity in a desired orientation during planting. In one embodiment, seed-adhered extruded pellets or granules of seed and/or plant supporting granular media of the present invention are of elongate construction to facilitate precision row planting of granules or pellets in the ground. If desired, one or more seeds can be oriented relative to such elongate granules or pellets during seed attachment, such as in the manner disclosed above, enabling each granule or pellet to be oriented during planting in the ground thereby orienting each seed attached to the planted pellet or granule relative to the ground, e.g., in a desired orientation relative to gravity. Whether oriented during seed-attachment to the granules or pellets or not, carrots and other relatively lightweight fine seed having at least 300 seeds per gram can be attached to each extruded granule or pellet producing seed-attached extruded granules or pellets that can be planted singly or in pairs in each spaced apart planting location, e.g., hole, in the ground. In a preferred embodiment, the granules or pellets are elongate advantageously facilitating use with an automated planting machine, e.g. a vibratory planter or the like, which helps automatically plant at least one and preferably at least a plurality of seed-carrying elongate extruded granules or pellets in each spaced apart planting location in the ground.

A preferred method seed attachment attaches at least one and preferably at least a plurality of seeds to each extruded granule or pellet that has been wetted enough to make the granules or pellets tacky enough for the seeds to stick to the outer surface of the tacky granules or pellets. In one preferred method of attachment where fine seed that preferably is grass seed is attached, at least a plurality of pairs, i.e. at least 3, of the seeds are attached to each extruded granule or pellet. In another preferred embodiment, at least 5 of the grass seeds are attached to each extruded granule or pellet thereby increasing germination density helping to produce a fuller denser and more even grass coverage.

As previously discussed, each of the extruded granules or pellets of seed and/or plant supporting granular media of the present invention are extruded from starch-containing admixture using a single screw or twin screw extruder operating at extruder operating conditions that produce extruded granules or pellets each containing sufficient water-soluble material that the outer surface of each granule or pellet at least becomes tacky when wetted. During seed attachment, the extruded granules or pellets are wetted to make them tacky, seeds are applied while tacky, and then the tacky seed-attached pellets or granules are allowed to dry. Once dry, the water-soluble material of the outer surface of each granule or pellet that had become tacky when wetted dries hardening around the attached seed binding them in place to each dried pellet or granule.

In another preferred method of seed attachment, a sufficient amount of water is added to enough extruded granules or pellets to form a starch-based adhesive slurry used to coat and/or attach one or more seeds to at least a plurality of pairs of extruded granules or pellets to produce at least a plurality of pairs of seed carrying granules or pellets of seed and/or plant supporting granular media. Such a starch-based adhesive slurry is formed by water causing water-soluble binder in at least a plurality of pairs of extruded granules or pellets to dissolve or otherwise solubilize and flow from the pellets in the form of starch-based flowable adhesive.

As a result, a starch-based adhesive binder containing slurry is formed where at least the liquid component of the slurry has a viscosity greater than water and preferably the slurry itself also has a viscosity greater than water. Such a starch-based adhesive binder containing slurry has enough water soluble binder from the wetted granules or pellets in the slurry that the liquid component of the slurry functions as a seed attachment or seed coating binder or adhesive.

In one preferred method, a conventional mixer or beater, such as a mixing tank, ribbon blender, or another type of mixer or beater, can be used to make the slurry as well as to mix seeds in the slurry with the slurry. In one preferred method of making the slurry, extruded granules or pellets and seeds are mixed together while water is added to cause water soluble binder in the pellets to dissolve and go into solution in the water. In another preferred method of making the slurry, water is added to the extruded pellets or granules before the seeds are added and mixed.

If desired, the water used to form the slurry can include one or more seed and/or plant supporting treatments, such as one or more fertilizers, e.g., micronutrients, one or more soil conditioners, e.g. inoculants and/or nitrogen-fixing bacteria, one or more seed supporting chemicals, or the like thereby forming a starch-based adhesive outer coating containing such one or more treatments. In one preferred method of coating seeds (and treating seeds during seed coating), one or more such treatments are either included in the water used to make the slurry or added to the slurry during mixing and/or seed coating to treat the seeds being coated while they are being coated. In one such preferred method of coating and treating seeds during seed coating, the resultant coating produced that forms a layer or film substantially completely encapsulating each coated seed preferably contains the one or more such treatments producing a treated seed coating and treated coated seeds.

As water is added to the granules or pellets causing water-soluble binder to be dissolved in the water and form the slurry, the viscosity of at least the liquid component of the slurry and preferably the slurry itself increases forming a slurry where at least the liquid component has a viscosity greater than water and preferably the slurry has a viscosity greater than water. In one preferred slurry making method, water in a sufficient amount is mixed together with extruded pellets or granules having sufficient water-soluble binder to form a slurry where at least the liquid component of the slurry and preferably the slurry itself has a viscosity greater than 5 centipoises and preferably has a viscosity greater than 10 centipoises. In another preferred slurry making method, water in a sufficient amount is mixed together with extruded pellets or granules having sufficient water-soluble binder to form a slurry where at least the liquid component of the slurry and preferably the slurry itself has a viscosity greater than 15 centipoises and preferably has a viscosity greater than 20 centipoises.

The amount of water as well as the amount of extruded granules or pellets of seed and/or plant supporting granular media used to make the slurry are controlled, regulated or otherwise determined depending upon the size and/or weight of the seeds to be coated with the viscosity of the slurry formed increasing with the size and/or weight of the seeds to be coated. For smaller seeds, e.g. light or fine seeds like beets or carrots, the viscosity of the slurry, preferably the viscosity of at least the liquid component of the slurry, can be less but preferably still is at least 5 centipoises. For larger seeds having less than 150 seeds per gram, the viscosity of the slurry, preferably the viscosity of at least the liquid component of the slurry, is greater and preferably is at least 10 centipoises. In another preferred method of seed coating, for even larger seeds having less than 100 seeds per gram, like wheat or corn, the viscosity of the slurry, preferably the viscosity of at least the liquid component of the slurry, is at least 15 centipoises. In still another preferred method of seed coating, for larger even larger seeds having less than 50 seeds per gram, like corn, the viscosity of the slurry, preferably the viscosity of at least the liquid component of the slurry, is at least 20 centipoises.

During mixing of the seeds in the slurry, the seeds preferably become coated by the water-soluble adhesive in the slurry gradually producing a coating that increases in thickness over time. In one preferred seed coating method implementation, the seeds are mixed with the slurry for a sufficient amount of time in the slurry having enough water soluble binder that at least a plurality of pairs of seeds and preferably each one of the seeds is coated with water-soluble binder producing an outer layer or film of the coating that is at least a plurality of microns thick. In one such preferred seed coating method implementation, seeds are mixed in the slurry until a coating of at least 5 μm is formed on at least a plurality of pairs of the seeds and preferably around each one of the seeds. In another such preferred seed coating method implementation, seeds are mixed in the slurry until a coating of at least 10 μm is formed on at least a plurality of pairs of the seeds and preferably around each one of the seeds. In still another such seed coating method implementation, seeds are mixed in the slurry until a coating of at least 15 μm is formed on at least a plurality of pairs of the seeds and preferably around each one of the seeds.

If desired the coated seeds (including treated coated seeds where the coating contains one or more seed and/or plant supporting treatments) can be used as coated without being subsequently bonded to or otherwise attached to any pellet. If desired, each one of the coated seeds can be dried after coating such as by being air dried, air dried in a convective oven, and/or dried in an oven at a temperature below that which adversely impacts seed viability. Where the coated seeds are intended to be used as is without being attached to any pellet or granule, the coated seeds preferably are dried after being coated using one or more of the aforementioned drying methods.

When planted, the coating on each one of the coated seeds helps support each seed by helping to promote germination, sprouting, growth and/or health. When watered or otherwise subjected to moisture, such a starch based coating can be or later become hydrophilic retaining at least some of the moisture helping to keep the seed moist longer facilitating germination, sprouting and/or growth. Such a starch based coating also can advantageously help support bacterial and fungal growth of bacteria and/or fungi beneficial to plant health and/or plant growth. Such a starch based coating can advantageously help support bacterial growth by providing carbohydrates, starches, and/or sugars that such beneficial bacteria can feed off of. Such bacteria that the starch based coating can help support include one or more types of nitrogen fixing bacteria, one or more types of nitrifying bacteria and/or one or more of glomus intraradices, G. mosseae, G. agregatum, Rhyzopogon villosullus, R. luteolus, R. amylopogon, R. fulvigleba, Pisolithus tinctorius, Trichoderma koningii, T. harzianum, streptomyces lydicus bacteria and/or trichoderma bacteria. Such a starch based coating can advantageously also help support one or more types of beneficial fungus or fungi. Even when such coated seeds are attached to extruded pellets or granules forming seed carrying or seed attached pellets or granules, the coating on each such seed also provides one or more of the aforementioned benefits.

Where the coated seeds are to be attached to extruded pellets or granules of seed and/or plant supporting granular media, the coated seeds are then mixed or agglomerated with granules or pellets of seed and/or plant supporting granular media using an agglomerator, such as a rotary drum agglomerator, pelletizer, coater or mixer. During seed attachment, the coated seeds are mixed with extruded pellets or granules that can include the same extruded pellets or granules to which water was added to make the slurry that coated the seeds. In another preferred embodiment of a method of seed attachment, extruded pellets or granules of seed and/or plant supporting granular media that have not been previously wetted preferably are used.

In carrying out a preferred method of seed attachment, at least a plurality of pairs of extruded pellets 36 of seed and/or plant supporting granular media 30 are added together with seed 72, preferably each seed 72 coated as discussed above, in such an agglomerator, pelletizer, coater or mixer. Depending upon the amount of tackiness or moistness of the outer coating of each one of the coated seeds 72, tumbling, mixing and/or agitation of the pellets 36 and coated seeds 72 can cause the seeds 72 to be attached, e.g. glued, to the pellets 36 without needing to add any moisture or water. Where the seeds 72 are larger than the extruded pellets 36, such tumbling, mixing and and/or agitation of the pellets 36 and seeds 72 preferably causes attachment of a plurality of pellets 36 to each seed 72 forming seed-carrying granules 78 as depicted in FIG. 6. In one preferred method of seed attachment, water is added such as by spraying or misting water inside the agglomerator, pelletizer, coater or mixer as the agglomerator, pelletizer, coater or mixer is tumbling, mixing and/or agitating the granules or pellets and the coated seeds.

Where water is added, an amount sufficient to cause at least some of the water-soluble binder in at least a plurality of pairs of the granules or pellets (preferably in each granule or pellet) being tumbled, mixed and/or agitated with the coated seeds inside of the agglomerator, pelletizer, coater or mixer is dissolved causing at least a portion of the outer surface of the at least a plurality of pairs of granules (preferably each granule or pellet) becomes tacky enough for one or more coated seeds to stick thereto. In addition, the added water also can tackify at least a portion of the outer surface of the coating of at least a plurality of pairs of the coated seeds (preferably each coated seed) thereby facilitating the ability of each coated seed to stick to one of the granules or pellets. Depending upon the amount of water added while the pellets or granules and coated seeds are being tumbled, mixed and/or agitated within the agglomerator, pelletizer, coater or mixer, enough water-soluble binder can be dissolved from at least a plurality of pairs of the granules or pellets (preferably from each granule or pellet) to cause at least some water-soluble binder, e.g. flowable adhesive, to flow from the pellets facilitating attachment of one or more coated seeds to at least a plurality of pairs of wetted granules or pellets (and preferably causing one or more coated seeds to be attached to each one of the granules or pellets inside the agglomerator, pelletizer, coater or mixer).

During seed attachment, the coated seeds and/or granules or pellets can be treated with one or more products or the like. For example, one or more innoculants, e.g., bacteria and/or fungi, fertilizers, and the like can be included in any water introduced, e.g. sprayed or misted, in the agglomerator, pelletizer, coater or mixer during seed attachment. If desired, these one or more products can be introduced into the agglomerator, pelletizer, coater or mixer in solid form, e.g., dried powdered form, such that the one or more products are applied to coated seeds and/or granules or pellets as they are being tumbled, agitated and/or mixed in the agglomerator, pelletizer, coater or mixer during seed attachment.

After seed attachment, the seed carrying or seed attached granules or pellets of seed and/or plant supporting granular media are dried to cure and hardening the water-soluble binder attaching the coated seeds to the granules or pellets thereby fixing the coated seeds to the granules or pellets. Performing such a drying step also preferably cures or hardens the coating of each one of the coated seeds. In one preferred drying step, each seed carrying granule or pellet and each coated seed attached thereto is allowed to air dry. In another preferred drying step, each seed carrying granule or pellet and each coated seed attached thereto is air dried in a convective dryer. In still another preferred drying step, each seed carrying granule or pellet and each coated seed attached thereto is oven dried at a temperature less than a temperature that would damage seed viability or cause premature seed activation, e.g. cause premature seed germination or sprouting.

In at least one preferred embodiment, the starch based coating of the coated seeds (and/or of the binder or adhesive attaching the coated seeds to the granules or pellets) can be and preferably does provide a protective barrier around each coated seed that helps protect the seed from fertilizers and/or other chemicals that might affect seed viability. In one such preferred embodiment, the starch based coating of each coated seed provides a protective barrier around each coated seed that permits one or more treatments to be applied during seed attachment that can include one or more fertilizers, e.g., micronutrients, chemicals, e.g., chemical treatments, and the like that normally would adversely affect seed viability. In one such preferred embodiment, the starch based coating of each coated seed is at least somewhat hydrophobic thereby forming a protective outer layer or film substantially completely encompassing each coated pellet that forms such a chemical barrier that enables application of one or more fertilizers, chemicals, e.g. chemical treatments, and the like that would normally adversely impact seed viability.

In at one preferred embodiment, the starch based coating of each coated seed preferably is initially at least somewhat hydrophobic to provide a protective layer around each coated seed that protects the seed from any treatments applied during seed attachment but later over time becomes more hydrophilic serving to absorb and retain moisture after being applied or planted. In one such preferred embodiment, the starch based coating of each coated seed is hydrophobic but becomes hydrophilic when exposed to the environment when applied or planted such as by being converted by one or more of ultraviolet radiation from the sun, bacteria in the soil, one or more fungi in the soil, and/or a treatment in the coating (such as a treatment applied during coating and/or seed attachment).

Seeds that can be coated with such a starch base coated as disclosed above include one or more of grass seed, carrot seed, wheat seed, corn seed, popcorn seed, beans, asparagus seed, basil seed, beet seed, broccoli seed, Brussel sprouts, celery seed, cucumber seed, dill seed, fennel seed, gourd seed, okra seed, onion seed, oregano seed, pepper seed, parsnip seed, pumpkin seed, radish seed, rhubarb seed, spinach seed, sunflower seed, tomato seed, turnip seed, watermelon seed and/or zucchini seed. Seeds that can be coated and attached in accordance with that described above include one or more of grass seed, carrot seed, wheat seed, corn seed, popcorn seed, beans, asparagus seed, basil seed, beet seed, broccoli seed, Brussel sprouts, celery seed, cucumber seed, dill seed, fennel seed, gourd seed, okra seed, onion seed, oregano seed, pepper seed, parsnip seed, pumpkin seed, radish seed, rhubarb seed, spinach seed, sunflower seed, tomato seed, turnip seed, watermelon seed and/or zucchini seed.

In another preferred method of seed attachment, one or more seeds can be coextruded with the pellets or granules of seed and/or plant supporting granular media. Where co-extrusion seed attachment is employed, one or more seeds can be extruded in a shell that substantially completely surrounds each pellet or granule with the shell formed of a third type of seed and/or plant supporting material that preferably is different than the first and second types seed and/or plant supporting materials of the extruded inner granules or pellets. In one preferred co-extrusion seed attachment method, a seed-containing shell is coextruded around each one of the granules or pellets producing at least a plurality of pairs of larger granules or pellets formed of extruded inner pellet or granule cores that are each surrounded by a seed-containing shell. Such a seed-containing shell not only includes one or more seeds but is formed of a third type of seed and/or plant supporting material that can be a hydrophilic material, e.g. super absorbent gel, a hydrophobic material, such as where it is desired to delay seed germination and/or sprouting, a fast acting fertilizer, a herbicide, such as to kill any foliage in close proximity, a pesticide and/or another type of seed and/or plant supporting material.

It is contemplated that such co-extruded multilayer granules or pellets can be coextruded with an outer shell or layer that does not contain any seeds. Whether the outer shell or layer contains any seeds or not, the following applies. The inner pellet or granule cores of each coextruded multilayer pellet or granule has a first type of seed and/or plant supporting material that can be a water-soluble seed and/or plant supporting material that can flow from each coextruded multilayer pellet or granule when wetted with a liquid, e.g., water, which can help treat the seed(s) and/or plant(s), feed the seed(s) and/or plant(s), condition the soil, e.g., via carrying or containing nitrogen-fixing bacteria, fertilize, via carrying or containing one or more micronutrients, provide a herbicide, provide a pesticide, and/or another type of treatment whose action can be and preferably is delayed to occur after the action of the third type of seed or plant supporting material of the outer shell. The water insoluble portion of each inner granule or pellet core that remains after wetting preferably provides a second type of seed and/or plant supporting material providing one or more treatments as described elsewhere herein whose action can be and preferably is delayed to occur after the action of the first type of seed and/or plant supporting material.

The inner granule or pellet core of each coextruded granule or pellet can also include a fourth type of material that can be oil absorbent and/or oil soluble. Where oil absorbent, the inner granule or pellet core of each coextruded granule or pellet can be treated with or otherwise include an oil-based treatment that only is released upon dissolving or degradation, e.g. biodegradation, of at least a portion of the water-soluble component of the inner granule or pellet core. Providing an extruded inner granule or pellet core of oil absorbent construction advantageously enables the inner granule or pellet core to be treated with oil-based treatments known to be toxic or otherwise averse to seed viability but which can be plant supporting after germination and/or sprouting of the seed.

The present invention also is directed to seed and/or plant supporting granular media formed of granules or pellets that can be spread in close proximity, in contact, or even together with seeds and/or plants providing support thereto during their germination, sprouting and/or growth. Such extruded granules or pellets of seed and/or plant supporting granular media can be used without having any seeds attached preferably being applied around, on and/or in the ground in close proximity to one or more plants, trees, shrubs, bushes or the like to help support plant growth and/or plant health. Such extruded seed and/or plant supporting granular media produces extruded pellets that not only serve as biodegradable mulch but which also function as a bulking agent that absorbs and retains moisture, e.g., water, which is released over time thereby helping support plant growth. Seed and/or plant supporting extruded pellets or granules of the present invention preferably also serve as a seed or plant supporting carrier that can carry not only food and/or water but which also can carry oil-based seed and/or plant supporting treatments, e.g., containing nitrogen-fixing bacteria and/or micronutrients. The following applies to extruded granules or pellets of seed and/or plant supporting granular media of the present invention with or without seeds attached as the benefits, features, characteristics and the like apply either way.

A preferred seed and/or plant supporting granular media is formed of extruded pellets having enough liquid soluble flowable material, e.g., water soluble flowable material, in each pellet that liquid soluble flowable material, e.g., water soluble flowable material, flows out from granules or pellets wetted with a liquid such as water, a liquid containing water or even another type of liquid that can be oil-based. Such liquid soluble flowable material, e.g., water soluble flowable material, which flows from wetted pellets is in the form of a first seed or plant supporting material preferably is different than a second seed or plant supporting material that remains in the pellets after wetting. In one preferred embodiment and method of manufacture, liquid soluble flowable material, e.g., water soluble flowable material, preferably is formed during gelatinization and/or extrusion of the mixture, e.g., admixture, from the extruder thereby producing seed or plant supporting extruded pellets that release liquid soluble flowable material, water soluble flowable material, when wetted.

One seed and/or plant supporting granular media of the present invention extruded from a preferred admixture under preferred extruder operating conditions forms extruded pellets having sufficient liquid-soluble flowable material, e.g., water soluble flowable material, in each pellet that liquid-soluble flowable material, e.g., water soluble flowable material, in each pellet wetted by liquid solubilizes and flows therefrom around and in between adjacent pellets binding them together. Some of the liquid wetting the pellets is absorbed thereby and released over time with at least some of the released liquid helping to support seeds and/or plants in close proximity, preferably in contact therewith, over an extended period of time following wetting. Some of the rest of the liquid wetting the pellets that solubilizes liquid-soluble flowable material, e.g., water soluble flowable material, causing it to flow therefrom also is released over time causing the liquid-soluble flowable material, e.g., water soluble flowable material, to function as an adhesive or binder that hardens the liquid is released, e.g. evaporates as the adhesive or binder dries, joining adjacent pellets together. At least some of the liquid released over time from the liquid-soluble flowable material as it hardens or cures also helps to support seeds and/or plants in close proximity, preferably in contact therewith.

As the liquid-soluble flowable material hardens or cures, pellets wetted thereby are joined together forming a mass of joined pellets that biodegrades more slowly over time thereby supporting seeds and/or plants in close proximity therewith for a longer period of time. This mass of joined pellets increases the area covered by the seed and/or plant supporting granular media of the present invention as compared to un-clumped granules or pellets in contact with one another (including granules or pellets in contact with one another which remain un-clumped after being wetted by liquid). Such increased surface area coverage provided by such a mass of joined pellets of the seed and/or plant supporting granular media of the present invention advantageously produces masses of joined pellets that serve as biodegradable mulch that covers a greater surface area than the (un-clumped) pellets alone did before wetting.

When pellets of seed and/or plant supporting granular media of the present invention are applied on the ground and wetted, masses of joined pellets are formed that more completely cover the ground than the un-clumped pellets did before wetting producing a plurality of mulch clumps that biodegrade more slowly than such pellets would biodegrade if not joined together or otherwise forming such clumps including during wetting. Mulch clumps formed of masses of joined pellets of seed and/or plant supporting granular media of the present invention not only cover a greater surface area of the ground than un-clumped granules or pellets (including granules or pellets in contact with one another which remain un-clumped after being wetted by liquid), the mulch clumps also advantageously better conserve moisture while also reducing weed growth over this greater surface area. In fact, such mulch clumps formed preferably are substantially imperforate such that each mulch clump more uniformly and more completely covers a given surface area of the ground as compared to un-clumped granules or pellets spread over the same surface area of ground.

The increased surface area of ground covered by mulch clumps formed by joined pellets of seed and/or plant supporting granular media of the present invention better traps ground moisture therebetween than un-clumped pellets or granules. In one preferred embodiment, such mulch clumps preferably trap a greater amount of moisture between each mulch clump and the ground than un-clumped pellets or granules. In one such preferred embodiment, such mulch clumps preferably trap a greater amount of moisture between each mulch clump and the ground than un-clumped pellets or granules covering the same surface area of ground covered by the mulch clumps.

In another such preferred embodiment, such mulch clumps preferably maintain a higher soil moisture content in the ground covered by the mulch clumps than the same surface area of ground covered by un-clumped pellets or granules. In still another such preferred embodiment, such mulch clumps preferably maintain a higher soil moisture content in the ground covered by the mulch clumps for a longer period of time than the same surface area of ground covered by un-clumped pellets or granules. In one such preferred embodiment, each one of a plurality of mulch clumps each formed of at least a plurality of pairs, i.e., at least three, pellets joined together by cured or hardened liquid-soluble flowable material maintains a water content in the soil underneath each mulch clump:

$$θ = \frac{{m}_{wet} - {m}_{dry}}{{ρ}_{w} \cdot {V}_{b}}$$

that is greater than a minimum soil moisture, θ_{pwp}, of the soil at which a plant wilts and which preferably maintains a water content in the mulch clump covered soil that is at least 25% greater than the minimum soil moisture, θ_{pwp}, at which a plant wilts. In another such preferred embodiment, each one of a plurality of mulch clumps each formed of at least a plurality of pairs, i.e., at least three, pellets joined together by cured or hardened liquid-soluble flowable material maintains a water content in the soil covered by each mulch clump:

$$θ = \frac{{m}_{wet} - {m}_{dry}}{{ρ}_{w} \cdot {V}_{b}}$$

within ±25% of the field capacity, θ_{fc}, of the soil and which preferably is no lower than about 15% of the field capacity, θ_{fc}, of the soil. In still another such preferred embodiment, each one of a plurality of mulch clumps each formed of at least a plurality of pairs, i.e., at least three, pellets joined together by cured or hardened liquid-soluble flowable material maintains a water content in the soil covered by each mulch clump:

$$θ = \frac{{m}_{wet} - {m}_{dry}}{{ρ}_{w} \cdot {V}_{b}}$$

within 50% of the field capacity, θ_{fc}, of the soil at least 5-6 days after a rain or irrigation and which preferably is no lower than about 20% of the field capacity, θ_{fc}, of the soil at least 5-6 days after a rain or irrigation. In a further such preferred embodiment, each one of a plurality of mulch clumps each formed of at least a plurality of pairs, i.e., at least three, pellets joined together by cured or hardened liquid-soluble flowable material maintains a water content in the soil covered by each mulch clump:

$$θ = \frac{{m}_{wet} - {m}_{dry}}{{ρ}_{w} \cdot {V}_{b}}$$

of no less than the field capacity, θ_{fc}, of the soil four (4) days after a rain or irrigation and which preferably maintains a water content in the soil covered by each mulch clump that is no less than the field capacity, θ_{fc}, of the soil five (5) days after a rain or irrigation.

A preferred seed and/or plant supporting granular media is formed of extruded pellets having enough water soluble flowable material in each pellet that water soluble flowable material flows out from granules or pellets wetted with liquid comprised of water, e.g., water or a liquid that contains water. Such water soluble flowable material that flows from wetted pellets is in the form of a first seed or plant supporting material preferably is different than a second seed or plant supporting material that remains in the pellets after wetting. In one preferred embodiment and method of manufacture, water soluble flowable material preferably is formed during gelatinization and/or extrusion of the mixture, e.g., admixture, from the extruder thereby producing seed or plant supporting extruded pellets that release water soluble flowable material when wetted with water.

As discussed in more detail below, when pellets formed of seed and/or plant supporting granular media of the present invention are spread on the ground and wetted with water (or a water-containing liquid), water-soluble first seed or plant supporting material of each one of the wetted pellets solubilizes or goes into solution in the water and flows out from the wetted pellets. Solubilized water-soluble first seed or plant supporting material flows from one or more of the wetted pellets onto the ground, into the ground, and/or between (and/or around) pellets wetting them with the solubilized water-soluble first seed or plant supporting material.

In one preferred seed and/or plant supporting granular media of the present invention, the first type provides a different type of support than the second type. In another preferred seed and/or plant supporting granular media, the second type provides seed and/or plant support for a longer period of time than the first type. In a further preferred seed and/or plant supporting granular media, the second type takes longer to degrade, preferably taking longer to biodegrade, than the first type. In still another preferred seed and/or plant supporting granular media, one of the types seed or plant supporting materials of the pellet, preferably the first type, provides and/or releases a faster acting fertilizer than another one of the types seed or plant supporting materials of the pellet, preferably the second type.

Where solubilized water-soluble first seed or plant supporting material flows onto and even into the ground on which the pellets have been applied, the water-soluble material impregnates the soil, as well as any seeds and/or plants in close proximity, including in contact therewith, with a first type of seed or plant supporting material that supports such seeds and/or plants differently than a second type of seed or plant supporting material that is less water soluble or preferably even water-insoluble which remains in the wetted pellets after the pellets have been wetted. In one preferred seed and/or plant supporting granular media, the first type provides a different type of support than the second type. In another preferred seed and/or plant supporting granular media, the second type provides seed and/or plant support for a longer period of time than the first type. In a further preferred seed and/or plant supporting granular media, the second type takes longer to degrade, preferably taking longer to biodegrade, than the first type.

One seed and/or plant supporting granular media of the present invention extruded from a preferred admixture under preferred extruder operating conditions forms extruded pellets having sufficient water-soluble flowable material in each pellet that water-soluble flowable material in each pellet wetted by water solubilizes and flows therefrom around and in between adjacent pellets binding them together. Some of the water wetting the pellets initially absorbed into what remains of the wetted pellets (after the water-soluble material flows away) is thereafter released over time. At least some of the absorbed and then released water helps support the seeds and/or plants in close proximity, preferably in contact with what is left of the previously wetted pellets, by watering the seeds and/or plants as it is released therefrom over an extended period of time following wetting. Some of the rest of the water wetting the pellets that solubilizes water-soluble flowable material causing water-soluble flowable material to flow therefrom is released over time from the resultant adhesive or binder joining the pellets together as the adhesive or binder cures or hardens. At least some of the water released from the water-soluble flowable material joining pellets together as it cures or hardens helps to support seeds and/or plants in close proximity, preferably in contact therewith, by watering the seeds and plants.

As the water-soluble flowable material hardens or cures, pellets wetted by the water-soluble flowable material become joined together forming a mass of clumped together pellets that biodegrades more slowly over time as compared to un-clumped granules or pellets (including extruded granules or pellets in contact with one another which remain un-clumped after being wetted by water), thereby supporting seeds and/or plants in close proximity therewith, preferably in contact therewith, for a longer period of time as compared to un-clumped granules or pellets (including extruded granules or pellets in contact with one another which remain un-clumped after being wetted by water). Extruded pellets of at least one preferred embodiment of a seed and/or plant supporting granular media of the present invention support seeds and/or plants by supporting at least one of seed and/or plant growth, and/or seed and/or plant health. Extruded pellets of at least one preferred embodiment of a seed and/or plant supporting granular media of the present invention support seeds and/or plants by supporting at least a plurality of seed and/or plant growth, and/or seed and/or plant health.

Such a mass of joined pellets increases the area covered by the seed and/or plant supporting granular media of the present invention as compared to un-clumped granules or pellets in contact with one another (including granules or pellets in contact with one another which remain un-clumped after being wetted by water). Such increased surface area coverage provided by such a mass of joined pellets of a seed and/or plant supporting granular media of the present invention advantageously produces masses of joined pellets that serve as biodegradable mulch that covers a greater surface area than the (un-clumped) pellets alone did before wetting with water.

When pellets 36 of seed and/or plant supporting granular media of the present invention are applied on the ground and wetted with water, a mass 74 of joined pellets 36 are formed that more completely cover the ground 66 than the mass 68 of un-clumped pellets did before wetting with water producing one or more mulch clumps 77 that biodegrade more slowly than such pellets 36 would biodegrade if not joined together or otherwise form such clumps 77 (including during wetting with water). Mulch clumps 77 formed of masses of joined pellets of seed and/or plant supporting granular media of the present invention not only cover a greater surface area of the ground than un-clumped granules or pellets spread over the same ground (including granules or pellets in contact with one another which remain un-clumped after being wetted by water), the mulch clumps 77 also advantageously better conserve moisture available to seeds and/or plants in close proximity thereto (including in contact therewith and/or covered thereby) while also reducing weed growth over the greater surface area covered by the mulch clumps. In fact, such mulch clumps formed preferably are substantially imperforate such that each mulch clump 77 more uniformly and more completely covers a given surface area of the ground as compared to un-clumped granules or pellets (including granules or pellets in contact with one another which remain un-clumped after being wetted by water) spread over the same surface area of ground.

In one preferred embodiment, each mulch clump 77 formed can be and preferably is substantially imperforate that each mulch clump 77 functions as a seal that seals in moisture in the soil below covered by the mulch clump providing a mulch clump 77 of substantially water-tight or water-proof construction. In another preferred embodiment, each mulch clump 77 formed preferably is of water-resistant construction but which has water-permeable surface(s) that absorbs and releases water at a rate slower than the water was absorbed over time preventing absorbed water from migrating all the way from an exposed or uncovered surface of the clump to an inner surface of the clump that overlies and covers the soil.

Pellets or granules of seed and/or plant supporting granular media of the present invention can be used as an all-natural bulking agent that allows for either nude use or agglomeration. Where agglomeration is performed, the agglomeration can be done to treat the granules or pellets with one or more treatments such as one or more treatments described above, a hydrophobic treatment, a hydrophilic treatment, one or more soil conditioners, one or more fertilizers, one or more pesticides, and/or one or more herbicides. Where agglomeration is performed, the agglomeration can be done to treat the granules or pellets by coating the granules or pellets with an outer coating containing one or more treatments. Such treatments can include one or more treatments as described above, a hydrophobic treatment, a hydrophilic treatment, one or more soil conditioners, one or more fertilizers, one or more pesticides, and/or one or more herbicides. While such treatments, e.g., nitrogen-fixing bacteria and/or micronutrients, can be applied via agglomeration, other methods of applying the treatments can be used including spraying the pellets or granules, diffusing one or more such treatments into the pellets or granules, extruding the pellets or granules from an admixture containing one or more such treatments, e.g., an admixture containing one or more micronutrients, and/or co-extruding the pellets or granules with an outer shell surrounding each one of the pellets composed of or include coatings containing one or more such treatments, e.g., nitrogen-fixing bacteria and/or one or more micronutrients.

In one preferred extruded granule or pellet embodiment of a seed and/or plant supporting granular media of the present invention, each granule or pellet can also include a another (third or fourth) type of material that can be and preferably is oil absorbent. Where oil absorbent, the granule or pellet can be treated with or otherwise include an oil-based treatment, e.g., oil eating bacteria, that is only released upon dissolving or degradation, e.g. biodegradation, of at least a portion of the water-soluble component of the granule or pellet. In a preferred embodiment, watering of granules or pellets upon or after being applied dissolves at least a portion of the outer surface of one or more of the wetted granules or pellets exposing the oil-based treatment-containing granule or pellet interior. Exposing the oil-based treatment-containing interior, e.g., such as containing one or more bacteria capable of digesting or breaking down oil and/or other petroleum products and/or distillates, can activate the oil-based treatment and/or allow the oil-based treatment to begin to work. Such a seed and/or plant supporting granular media of the present invention formed of extruded granules or pellets of oil absorbent construction that include or have otherwise been treated with one or more oil-based plant supporting treatments advantageously enables use of an oil-based treatment known to be toxic or otherwise adverse to seed viability but which can be plant supporting after germination and/or sprouting of the seed.

In one preferred embodiment, each extruded granule or pellet preferably has a plurality of pairs of types of seed and/or plant supporting treatments or components with a 1^{st} one of the treatments or components being fast acting as it is water soluble and therefore can start, occur or be activated upon being watered during or after being applied e.g., planted and/or applied on the ground. A 2^{nd} one of the treatments or components preferably is less water soluble or water insoluble thereby delaying start, occurrence or activation until after the 1^{st} one of the treatments or components starts, occurs or activates. Where oil absorbent and an oil-based treatment has been applied or otherwise included in each pellet, a 3^{rd} one of the treatments or components preferably is provided by the oil-based treatment. In a preferred embodiment, the oil-based treatment is interiorly disposed within the granule or pellet such that the oil-based treatment is released or activated only after at least a portion of the outer surface of the pellet or granule is dissolved or degraded, e.g. biodegraded, exposing the pellet or granule interior including a portion containing the oil-based treatment.

Such a granule or pellet of a seed and/or plant supporting granular media of the present invention can be extruded with one or more treatments or components that preferably are seed and/or plant supporting components or treatments that include one or more fertilizers, pesticides and/or herbicides. Such granules or pellets can be extruded with other components including urea, phosphates, trace minerals, e.g. boron, selenium, etc., as well as with one or more fertilizers and/or herbicides. Pellets or granules containing urea can also be treated with DCD or a urease inhibitor thereby producing pellets that more slowly release nitrogen as the urea is degraded by nitrogen fixing bacteria. This allows for use of a lesser amount of DCD type products as the DCD is in direct proportion needed to treat the urea rather than needing to over applying the DCD to ensure delayed nitrogen release.

When applied in the field with the first rain or irrigation, the wetting of the pellet releases the soluble starches allowing for the pellet to shrink to a smaller size. The starches in the pellet and/or outer seed coating(s) then begin to exhibit hydrophobic characteristics dispelling the water to the surrounding soil and the starches retrograde making the pellet less water absorptive thereby lowering biodegradability. The result is a seed and/or plant supporting granular media of the present invention formed of extruded granules or pellets that cannot only clump together but which also have delayed biodegradability providing even further or more delayed or more extended time release than other types of biodegradable products used for similar applications. Where the pellet has some soil treatment chemicals on the surface available for immediate soil treatment, at least some of the other soil treatment chemicals, preferably the majority of the chemicals are trapped in the starch matrix for slow release into the soil as the starches biodegrade. This extends the treatment time of the extruded pellets or granules in the planted area and/or in the area in which the pellets or granules were applied.

Many pesticides and herbicides and chemicals used for soil treatment are poorly water soluble, not very water-soluble, or even not water-soluble but will be absorbed in the extruded pellets or granules of seed and/or plant supporting granular media of the present invention due to a matrix formed during pellet gelatinization and/or extrusion that can be and preferably is a starch matrix that produces pellets or granules that are oil absorbent. This eliminates the use of adjuvants or emulsifiers thereby advantageously lowering the production and/or application costs while also advantageously increasing the precision of the applications. This also eliminates having to aerosol many of the pesticides and herbicides as such oil-based herbicides and/or pesticides can be applied via extruded pellets and/or granules of the present invention which function as oil-based herbicide and/or pesticide delivery devices or vehicles that also advantageously are biodegradable once the herbicide and/or pesticide treatment has been delivered. Spraying chemicals in agricultural applications has an efficiency of application of as low as 15%—that is 85% of the product is wasted and ends up polluting the air and creating a toxic environment. Using extruded granules and/or pellets of the present invention enables the granules or pellets to be more evenly applied over the treated area without having to allow for losses to the environment due to evaporation, wind blowing the herbicide/pesticide aerosols off course, etc. as a result, oil absorbent extruded pellets or granules formulated in accordance with the present invention with one or more oil-based herbicides and/or pesticides advantageously more efficiently deliver the herbicides and/or pesticides to the desired treatment area thereby reducing application costs and unintended misapplication that tends to occur with herbicides and/or pesticides that are sprayed on or delivered via aerosol application.

Pellet size can be changed, set or otherwise provided depending on or for the intended site of application and/or for site specific applications. Pellets having higher ratios of starches to chemicals can extend the treatment multiple months depending also on the size of the pellet and the available water the treatment may extend well into 3 months. Where co-extruded, seed and/or plant supporting granular media can be done where chemicals for treatment, e.g. plant supporting treatment, can be injected into the center of an extrusion for measured applications in fields, rows or planters after application and/or planting.

Where intended for aquatic or aquaculture use, such extruded granules or pellets can have a plurality of pairs of types of components with one of the components being water soluble and immediately activating upon contact with the water by being dissolved into the water providing a rapid 1^{st} stage of treatment. Another one of the components can be provided by what remains of each granule or pellet after the water-soluble component dissolves that provides a 2^{nd} stage of aquatic or aquacultures treatment that starts, occurs or activates after the 1^{st} treatment stage. A 3^{rd} one of the components can be provided by an oil-based treatment that has been absorbed by at least an oil absorbent part of each granule or pellet during application war extrusion with the oil-based treatment. The 3^{rd} one of the components can start, occur or activate after the 1^{st} treatment stage and provides a type of treatment different than the type of treatment provided by either the 1^{st} treatment stage or the 2^{nd} treatment stage.

Depending upon the size of the extruded pellets 36 and the size of the seed 72, one or more pellets 36 can be attached to the coated seed 72. Where the pellets or granules are smaller than the size of the seed that is coated, the coating can be used as an adhesive to which one or more of the pellets or granules are attached. Attachment of the granules or pellets can be performed during coating and/or during agglomeration. As is shown above, the starch based binder or adhesive coating substantially completely covers the entire elongate seed with a film or layer of the coating that is at least a plurality of pairs of microns thick and which preferably is at least 5 μm thick. Depending upon the viscosity of the slurry used to make the coating material, even thicker coatings can be applied where slurries having greater viscosities are used.

Each seed 72 shown in FIGS. 6-8 is elongate with extruded pellets 36 shown attached to each coated seed 72 being smaller and formed of pellets 36 extruded of sorghum from an admixture preferably formed of whole grain sorghum seed. Such an admixture can be substantially completely formed of one or more cereal grains and/or can include one or more such seed and/or plant supporting treatments in the admixture that is extruded with and in the pellet or granule. In one preferred embodiment, the pellets are extruded from an admixture formed substantially completely of sorghum, preferably whole grain sorghum with less than 10% of the admixture formed of or otherwise containing one or more such treatments that are extruded with and/or in the pellet or granule during extrusion. Such treatments can be oil-based, e.g., in the form of an oil, which is added to the admixture before and/or during extrusion forming extruded pellets or granules with oil-based treatment in its matrix, e.g. starch based matrix, formed during gelatinization and/or extrusion.

Seed 72 can be a hull of a wheat seed that has been coated with a starch-based material composed of starch based binder formed from water soluble binder produced by a slurry of water and pellets or granules extruded from a corn-based admixture. Each such seed can be coated and then applied to an extruded pellet or granule that is larger in size during seed attachment but can also include a plurality of smaller extruded pellets or granules attached to the seed, such as by being attached to the coating of the seed like the extruded sorghum pellets attached to the hull of the wheat seed as shown in FIG. 6.

As such, the present invention contemplates attachment of one or more extruded pellets or granules to a single seed, one or more seeds to a single seed, as well as combinations thereof where the seed has a plurality of extruded pellets or granules smaller in size than the seed with the seed in turn attached to a larger extruded pellet or granule. Where a seed and/or extruded pellet or granule attached thereto or having one or more seeds attached to the pellet or granule has a plurality of granules or pellets attached thereto that are smaller than the seed and/or larger pellet or granule, such a clump of pellets and/or seeds can contain a plurality of extruded pellets or granules extruded from different cereal grains thereby providing different seed and/or plant supporting characteristics.

Extruded pellets or granules of seed and/or plant supporting granular media in accordance with the present invention can include or be extruded with an animal repellant, such as sodium lauryl sulfate 19% and/or cloves 6%, in the admixture and/or otherwise treated after extrusion with such an animal repellent such as during seed coating and/or agglomeration. Extruded pellets or granules of seed and/or plant supporting granular media in accordance with the present invention can include or be extruded with mycorhizal fungi, e.g., endomycorhizal and/or ectomycorhizal fungi, which can help promote nutrient release and/or conversion and/or function as an inoculant, e.g., soil inoculant. If desired, the extruded pellets or granules can be treated after extrusion such as during seed coating and/or agglomeration.

If desired, extruded granules or pellets and/or seeds, including co-extruded granules or pellets, can include or otherwise be coated with a hydrating gel, such as one containing potassium polyacrylate, e.g. 93% potassium polyacrylate, that is a hydrophilic or water absorptive, if desired, the pellets or granules can be extruded from an admixture containing such a hydrating gel producing pellets or granules that are more hydrophilic. If desired, such a hydrating gel can be or otherwise include cross-linked acrylamide/potassium acrylate copolymer or another suitable hydrophilic substance capable of absorbing at least 50 times and preferably at least 100 times its weight in water.

In a preferred embodiment, the extruded granules or pellets are extruded having a size of between 0.2 mm and 0.8 mm for applications requiring smaller pellet or granule sizes, such as where fine or light seeds are used. In another preferred embodiment, the extruded granules or pellets are extruded having a size of between 1 mm and 2 mm for applications requiring a medium pellet or granule size, such as where medium-sized or medium weight seeds are used. In still another preferred embodiment, the extruded granules or pellets are extruded having a size of between 2 mm and 4 mm for applications requiring a larger pellet or granule size, such as where larger-sized or heavier weight seeds are used.

If desired, seeds and/or pellets or granules can be extruded or treated, e.g. coated with Glomus intraradices, G. mosseae, G. agregatum, Rhyzopogon villosullus, R. luteolus, R. amylopogon, R. fulvigleba, Pisolithus tinctorius, Trichoderma koningii, T. harzianum, beneficial bacteria, and/or root stimulants, e.g., minimum of 44 endo spores per gram. If desired, seeds and/or pellets or granules can be extruded or treated, e.g. coated with streptomyces lydicus bacteria (and/or Trichoderma bacteria) that can function as a soil amendment that is a root colonizing bacteria that protects and mobilizes nutrients, especially iron, which can include chelated iron and humates. Can be coated or extruded with one or more humates, e.g., made, formed or comprised of one or more salts of humic acid(s), such as/including potassium humate formed of the potassium salt of humic acid to increase the efficiency of extruded granular pellets comprised of and/or coated with nitrogen and/or phosphorus-based fertilizer inputs. Where the extruded granular pellets are intended for aquaculture use, one or more such humates can be included, such as in the form of sodium humate.

If desired, such granular plant or flora supporting media of the present invention can also include seeds either mixed there with or carried by one or more plant or flora supporting granules. In one such preferred granular plant or flora supporting media embodiment that includes seeds, there seeds can be freely mixed in with the rest of the plant or flora supporting granules producing a media mixture where the seeds in granules are all applied on the ground or planted in the ground together. In one such preferred embodiment, the seeds and extruded pellets are mixed together dry forming a granular plant or flora supporting media that is stored ready for use in a dry condition with the seeds not attached to the pellets and the pellets not attached to the seeds. Where such a preferred embodiment of granular plant or flora supporting media is a dry mixture of seeds and extruded pellets, it can also contain fines, non-extruded granules and non-extruded pellets which preferably are also not attached to any seed. Where such a preferred embodiment of granular plant or flora supporting media is a dry mixture of seeds and extruded pellets, it can be and preferably is applied together with water or an aqueous solution that can and preferably does activate any living organism, e.g., bacteria, such as nitrogen fixing bacteria, and/or inoculant, e.g., inoculating fungi, contained therein. It can be entrained in a stream of water or aqueous solution that wets the mixture as it is carried by the stream in being applied on the ground or other desired application area. It can also be applied dry on the ground before wetted with water or another aqueous solution, if desired.

In another preferred granular plant or flora supporting media embodiment, each seed has one or more extruded pellets and/or extruded fines attached thereto preferably via adhesive attachment using starch-based water-soluble binder in and/or or from the pellets and and/or fines being attached thereto or using such starch-based water-soluble binder obtained from other sources including other pellets and and/or fines. In still another preferred granular plant or flora supporting media embodiment, each one of the extruded pellets can be extruded with a plurality, preferably a plurality of pairs, i.e. at least three, seeds and and/or can carry a plurality, preferably a plurality of pairs, i.e. at least three, seeds adhesively attached thereto by such starch-based water-soluble binder.

In still another preferred granular or flora supporting media embodiment, polyvinyl alcohol can be used to facilitate seed and extruded pellet attached being used to adhesively attach one to the other. If desired, the seeds can be pretreated with polyvinyl alcohol to produce an outer surface of each seed, e.g., polyvinyl alcohol coating around each seed, making seed to pellet attachment more amenable before being adhesively attached to pellet(s) via water soluble binder adhesive attachment. In a further preferred granular or flora supporting media embodiment, polyvinyl acetate can be used to facilitate seed and extruded pellet attached being used to adhesively attach one to the other. If desired, the seeds can be pretreated with polyvinyl acetate to produce an outer surface of each seed, e.g., polyvinyl acetate coating around each seed, making seed to pellet attachment more amenable before being adhesively attached to pellet(s) via water soluble binder adhesive attachment.

In a preferred embodiment, one or more of the extruded pellets are impregnated, coated or otherwise treated with nitrogen fixing bacteria, preferably free living nitrogen fixing bacteria, such as one or more of clostridium, klebsiella, rhodobacter, nostoc, and/or azotobacter, in a form which activate or become activated when the pellets are wetted with water or another aqueous solution. In another preferred embodiment, one or more pellets of the granular plant supporting media are impregnated, coated or otherwise treated with symbiotic nitrogen fixing bacteria, such as one or more of rhizobium and/or azospirillum, depending on the nature of the seeds and/or plant media to be nourished with nitrogen produced from such symbiotic nitrogen fixing bacteria. Where the extruded pellets are part of a plant or flora supporting media of the present invention intended to be used in aquatic applications in lakes, ponds, rivers, streams, and other bodies of water, where the granular plant or flora supporting media is applied to or in such a body of water, one or of the extruded pellets, preferably substantially all of the pellets are impregnated, coated or otherwise treated with a nitrogen fixing algae, such as a cyanobacteria, e.g. an anabaena algae or a nostoc algae.

In use and operation, granules of the plant or flora supporting media are applied in the desired area by spreading the granules on the ground and water preferably is used to activate the granules to cause them to at least begin to release their respective treatments, fertilizers, plant beneficial bacteria and and/or plant beneficial inoculants. Application of water not only causes such activation but also causes plant or flora supporting granules formed of extruded pellets to at least partially solubilize thereby releasing solubilize starch into the surroundings providing plant supporting starch that can help facilitate more rapid seed germination and and/or plant growth.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A granular plant supporting media comprised of a plurality of granules of a starch-containing material used in supporting seed germination or plant growth.

2. The granular plant supporting media of claim 1 wherein each one of the starch-containing granules is comprised of a water soluble starch based binder.

3. The granular plant supporting media of claim 2 wherein applying water to the granules attaches them together forming a mulch clump that absorbs and retains moisture that is thereafter released over time providing seed germinating initiating or plant growth supporting moisture to the area surrounding the mulch clump.

4. The granular plant supporting media of claim 2 further comprising a plurality of seeds, each seed having a plurality of the starch-containing granules attached thereto.

5. The granular plant supporting media of claim 4 wherein each one of the starch-containing granules comprises a pellet extruded from a starch-containing admixture.

6. The granular plant supporting media of claim 5 wherein each seed has a plurality of extruded pellets attached thereto.

7. The granular plant supporting media of claim 6 wherein the plurality of extruded pellets attached to each seed are attached by a starch-based water-soluble binder.

8. The granular plant supporting media of claim 6 wherein the plurality of extruded pellets attached to each seed are attached by a starch-based water-soluble binder formed of starch in each extruded pellet during pellet extrusion.

9. The granular plant supporting media of claim 5 wherein each extruded pellet is comprised of a starch-based water-soluble binder that facilitates seed attachment when the extruded pellet is wetted with water.

10. The granular plant supporting media of claim 9 further comprising a plurality of starch-containing particles that are each smaller in size than the extruded pellets, each one of the plurality of smaller sized starch-containing particles being attached to each seed.

11. The granular plant supporting media of claim 2 further comprising a plurality of seeds, each one of the starch-containing granules having a plurality of seeds attached thereto.

12. The granular plant supporting media of claim 11 wherein each one of the starch-containing granules comprises a pellet extruded from a starch-containing admixture, and each extruded pellet has a plurality of the seeds attached thereto.

13. The granular plant supporting media of claim 12 wherein the plurality of seeds are attached to each extruded pellet with a starch-based water-soluble binder.

14. The granular plant supporting media of claim 13 wherein the plurality of seeds attached to each extruded pellet by water-soluble binder formed of starch in each extruded pellet during pellet extrusion.

15. The granular plant supporting media of claim 1 wherein the granular plant supporting media is comprised of a plurality of extruded pellets and a plurality of seeds.

16. The granular plant supporting media of claim 15 wherein the granular plant supporting media is further comprised of a plurality of starch-containing particles that are each smaller in size than the extruded pellets.

17. The granular plant supporting media of claim 16 wherein the granular plant supporting media is further comprised of a plurality of a plurality of non-extruded granules comprised of one of a fertilizer and insecticide.

18. The granular plant supporting media of claim 15 wherein the granular plant supporting media is further comprised of a plurality of a plurality of non-extruded granules comprised of one of a fertilizer and insecticide.

19. The granular plant supporting media of claim 1 wherein the granular plant supporting media is comprised of a plurality of extruded pellets and a plurality of non-extruded granules comprised of one of a fertilizer and insecticide.

20. The granular plant supporting media of claim 19 wherein the granular plant supporting media is further comprised of a plurality of starch-containing particles that are each smaller in size than the extruded pellets.

21. The granular plant supporting media of claim 19 wherein the granular plant supporting media is further comprised of a plurality of seeds.

22. The granular plant supporting media of claim 1 wherein the granular plant supporting media is comprised of a plurality of extruded pellets and a plurality of starch-containing particles smaller in size than each one of the extruded pellets.

23. The granular plant supporting media of claim 22 wherein the granular plant supporting media is further comprised of a plurality of a plurality of non-extruded granules comprised of one of a fertilizer and insecticide.

24. The granular plant supporting media of claim 22 wherein the granular plant supporting media is further comprised of a plurality of seeds.
